(19) United States
(12) Patent Application Publication
(10) Pub. No.: US 2017/0339732 A1
(43) Pub. Date: Nov. 23, 2017

(54) COMMUNICATION SYSTEM, COMMUNICATION DEVICE, COMMUNICATION MANAGEMENT DEVICE, AND RECORDING MEDIUM

(71) Applicants: Kengo MATSUYAMA, Tokyo (JP); Yoshimitsu SHIOTANI, Kanagawa (JP)

(72) Inventors: Kengo MATSUYAMA, Tokyo (JP); Yoshimitsu SHIOTANI, Kanagawa (JP)

(21) Appl. No.: 15/587,474

(22) Filed: May 5, 2017

(30) Foreign Application Priority Data
May 17, 2016 (JP) 2016-098811

(51) Int. Cl. H04W 76/02; H04L 29/06; H04W 12/04; H04W 88/04; H04W 84/12

(52) U.S. Cl. CPC H04W 76/023; H04W 76/022; H04L 63/06; H04L 63/0428; H04W 12/04; H04W 84/12; H04W 88/04

(57) ABSTRACT

A communication system includes a plurality of first communication devices to form different network cells through first wireless communication, and a second communication device to communicate with the first communication devices through the first wireless communication. The second communication device includes: a first memory to store connection information for establishing a connection with the plurality of first communication devices through the first wireless communication; a communication circuit to connect, when data is received from one first communication device among the plurality of first communication devices, the second communication device with other first communication device different from the one first communication device through the first wireless communication using the connection information; and circuitry to transfer the data received from the one first communication device by the second communication device to the other first communication device.

### CROSS-REFERENCE TO RELATED APPLICATIONS

This patent application is based on and claims priority pursuant to 35 U.S.C. §119(a) to Japanese Patent Application No. 2016-098811, filed on May 17, 2016, in the Japan Patent Office, the entire disclosure of which is hereby incorporated by reference herein.

### BACKGROUND

### Technical Field

The present invention relates to a communication system, a communication device, a communication management device, and a non-transitory recording medium.

### Description of the Related Art

Institute of electrical and electronics engineers (IEEE) 802.11ad is known as a wireless communication standard in which high-speed data transmission is performed using a millimeter wave (60 GHz) band having high radio wave rectilinearity and a relatively narrow communication range.

Further, communication networks in which data content is broadcast and distributed from a transmitter node to a plurality of receiver nodes via a relay receiver node are known. It is difficult to apply such multihop communication to a communication system in which communication is performed using a millimeter wave band.

### SUMMARY

Example embodiments of the present invention include a communication system provided with a plurality of first communication devices to form different network cells through first wireless communication, and a second communication device to communicate with the first communication devices through the first wireless communication. The second communication device includes: a first memory to store connection information for establishing a connection with the plurality of first communication devices through the first wireless communication; a communication circuit to connect, when data is received from one first communication device among the plurality of first communication devices, the second communication device with other first communication device different from the one first communication device through the first wireless communication using the connection information; and circuitry to transfer the data received from the one first communication device by the second communication device to the other first communication device.

Example embodiments of the present invention include a communication device to communicate with a second communication device through second wireless communication, the second communication device being capable of communicating with a plurality of first communication devices through first wireless communication, the second wireless communication having a wider communication range than the first wireless communication. The communication device includes: circuitry to collect information of network cells which are formed by the first communication device and different in the first wireless communication from the plurality of first communication devices through the second wireless communication and provide at least some of connection information which is used for the second communication device to establish a connection with the first communication device through the first wireless communication to the second communication device through the second wireless communication based on the collected information.

Example embodiments of the present invention include a method performed by any one of the plurality of communication devices in the communication system, and a non-transitory recording medium storing a plurality of instructions which, when executed by a processor, cause the processor to perform such method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIGS. 1A and 1B are diagrams illustrating an exemplary network configuration of a millimeter wave wireless communication system according to one embodiment;

FIG. 2 is a diagram illustrating an example of a time slot of a TDMA protocol according to one embodiment;

FIG. 3 is a diagram for describing an example of beamforming according to one embodiment;

FIG. 4 is a diagram illustrating an example of a system configuration of a communication system according to one embodiment;

FIG. 5 is a diagram illustrating another example of a system configuration of a communication system according to one embodiment;

FIG. 6 is a diagram illustrating an example of a hardware configuration of a communication device according to one embodiment;

FIG. 7 is a diagram illustrating exemplary functional configurations of communication devices included in a communication system according to one embodiment;

FIGS. 8A to 8C are diagrams illustrating an example of connection information stored in an STA according to a first embodiment;

FIG. 9 is a sequence diagram illustrating an example of a communication process according to the first embodiment;

FIGS. 10A to 10C are diagrams illustrating an example of connection information stored in an STA according to a second embodiment;

FIG. 11 is a sequence diagram illustrating an example of a communication process according to the second embodiment;

FIGS. 12A to 12C are diagrams illustrating an example of connection information stored in an STA according to a third embodiment;

FIGS. 13 and 14 are sequence diagrams illustrating an example of a communication process according to the third embodiment;

FIG. 15 is a sequence diagram illustrating an example of an information provision process according to a fourth embodiment;

FIGS. 16A to 16F are diagrams illustrating an example of connection information stored in an STA according to the fourth embodiment;

FIG. 17 is a flowchart of a data transfer process of an STA according to the fourth embodiment;

FIG. 18 is a sequence diagram illustrating an example of a connection process of the STA according to the fourth embodiment;

FIG. 19 is a sequence diagram illustrating an example of a data transmission process according to the fourth embodiment;

FIG. 20 is a sequence diagram illustrating an example of an information provision process according to a fifth embodiment;

FIGS. 21A to 21C are diagrams illustrating an example of STA information stored in a PCP according to the fifth embodiment;

FIG. 22 is a flowchart of a data transfer process of the PCP according to the fifth embodiment;

FIG. 23 is a flowchart of a data transmission process of the PCP according to the fifth embodiment;

FIG. 24 is a flowchart of a data transmission process of an STA according to the fifth embodiment;

FIG. 25 is a flowchart of a communication control process of a communication management device according to the fifth embodiment;

FIG. 26 is a diagram illustrating an example of a communication path reduction process according to the fifth embodiment;

FIGS. 27, 28, and 29 illustrate an example of a data transmission process according to the fifth embodiment;

FIG. 30 is a sequence diagram illustrating an example of an encryption key sharing process according to a sixth embodiment; and

FIG. 31 is a sequence diagram illustrating another example of an encryption key sharing process according to the sixth embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, exemplary embodiments of the present invention will be described with reference to the appended drawings.

<Overview of Millimeter Wave Wireless Communication System>

Before embodiments of the present invention are described, an overview of millimeter wave wireless communication systems according to embodiments of the present invention will be described.

The millimeter wave wireless communication system is a wireless communication system in which high speed data transmission is performed using a millimeter wave (60 GHz) band having high radio wave rectilinearity and a relatively narrow communication range. Here, the following description will proceed under the assumption that a millimeter wave wireless communication system is a wireless communication system conforming to an institute of electrical and electronics engineers (IEEE) 802.11ad. IEEE802.11ad is an example of a millimeter wave wireless communication system according to the present embodiment.

(Network Configuration)

In the millimeter wave wireless communication system conforming to IEEE 802.11ad, communication is performed using a millimeter wave (60 GHz) band having high radio wave rectilinearity and a relatively narrow communication range, and high speed data communication is realized using a wide band of 2.16 GHz per channel.

In the millimeter wave band, a propagation loss of radio waves is large. Thus, in the millimeter wave wireless communication system, in order to increase an antenna gain, a beamforming technique of narrowing down a beam direction of radio waves and performing transmission and reception of radio waves is used. For this reason, in the millimeter wave wireless communication system, it is difficult for a communication device to simultaneously communicate with a plurality of other communication devices around the communication device.

Therefore, in the millimeter wave wireless communication system, instead of a carrier sense multiple access with collision avoidance (CSMA/CA) scheme used in a wireless local area network (LAN) system of a related art, a communication protocol of a time division multiple access (TDMA) scheme is used as a wireless multiplexing scheme.

In the millimeter wave wireless communication system, a coordinator device called a PBSS central point (PCP) forms a network cell called a personal basic service set (PBSS) and manages time slots in the TDMA protocol.

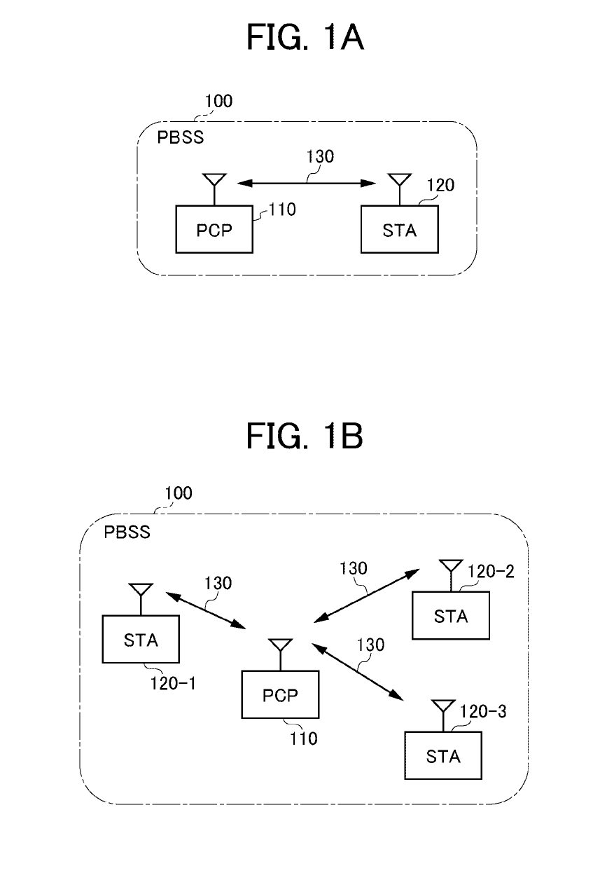

FIGS. 1A and 1B are diagrams illustrating an exemplary network configuration of a millimeter wave wireless communication system according to one embodiment. FIG. 1A illustrates an example of a one-to-one network configuration in which a PCP 110 forming a PBSS 100 serving as a network cell of a millimeter wave wireless communication system communicates with a station (STA) 120 through millimeter wave wireless communication 130. In the example of FIG. 1A, the PCP 110 manages time slots in the TDMA protocol, and transmits a beacon frame, for example, at predetermined time intervals.

FIG. 1B illustrates an example of a star-type network configuration in which the PCP 110 forming the PBSS 100 communicates with a plurality of STAs 120-1 to 120-3 through millimeter wave wireless communication 130. In an example of FIG. 1B, the PCP 110 manages time slots in the TDMA protocol, and transmits a beacon frame, for example, at predetermined time intervals.

(Configuration of Time Slot)

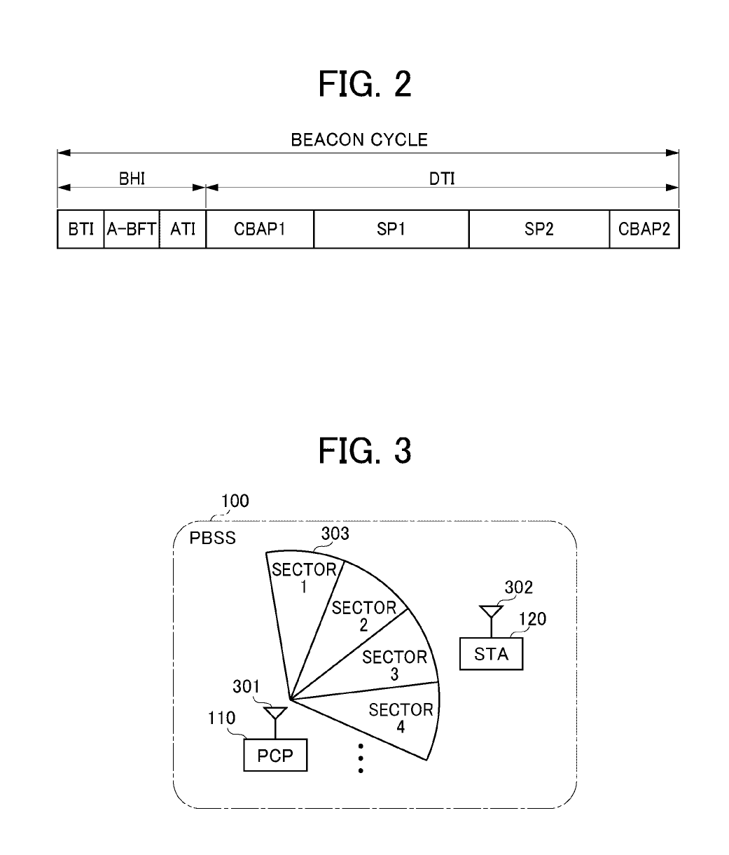

FIG. 2 is a diagram illustrating an example of a time slot according to one embodiment. FIG. 2 illustrates allocation of time slots in the TDMA protocol managed by the PCP 110. As illustrated in FIG. 2, time slots of the TDMA protocol managed by the PCP 110 include a beacon header interval (BHI) and a data transfer interval (DTI).

The BHI includes a beacon transmission interval (BTI), an association beamforming training (A-BFT), and an announcement transmission interval (ATI).

The BTI is a period in which the PCP 110 transmits a beacon frame. The A-BFT is a beamforming training period. The ATI is a period in which transmission and reception of management information, control information, and the like are performed between the PCP 110 and the STAs 120-1 to 120-3.

The DTI includes a contention based access period (CBAP) and a service period (SP).

The CBAP is a contention period which is allocated so that the PCP 110 and the plurality of STAs 120 perform communication with each other by competition. The SP is a dedicated period which is allocated so that communication is performed between the PCP 110 and one STA 120.

In the BTI, the PCP 110 transmits beacon frames which are equal in number to antenna sectors which are a plurality of beam patterns formed by the PCP 110. On the other hand, each of the STAs 120-1 to 120-3 sets an omnidirectional antenna or a quasi-omnidirectional antenna, receives all the beacon frames transmitted from the PCP, and feeds information indicating an antenna sector having the best reception quality back to the PCP 110. Accordingly, the PCP 110 can detect whether or not communication with each of the STAs 120-1 to 120-3 can be performed using the antenna sector.

(Beam Forming)

Here, an overview of a sector level sweep (SLS) will be described as an example of a beamforming technique.

There are two types of SLS: Tx sector sweep (TXSS); and Rx sector sweep (RXSS). The TXSS is beamforming training for deciding an antenna sector to be used at the time of transmission, and the RXSS is beamforming training for deciding an antenna sector to be used at the time of reception.

FIG. 3 is a diagram for describing an example of beamforming according to one embodiment. In an example of FIG. 3, for the sake of simple description, only four antenna sectors of sectors 1 to 4 are illustrated among antenna sectors which are a plurality of beam patterns formed by the PCP 110.

In the TXSS, the PCP 110 sequentially transmits a predetermined packet from an antenna 301 while switching sectors (sectors 1 to 4) of a plurality of beam patterns 28. On the other hand, the STA 120 sets an antenna 302 as an omnidirectional antenna or a quasi-omnidirectional antenna, receives the packet transmitted from the PCP 110, and feeds information indicating the antenna sector having the best reception quality back to the PCP 110.

In the RXSS, a beamforming training sequence in a direction opposite to the beamforming of the TXSS is executed, and when the TXSS and the RXSS are completed, transmission and reception of radio waves by the millimeter wave wireless communication can be performed between the PCP 110 and the STA 120.

<System Configuration>

Next, a configuration of the communication system according to the present embodiment will be described.

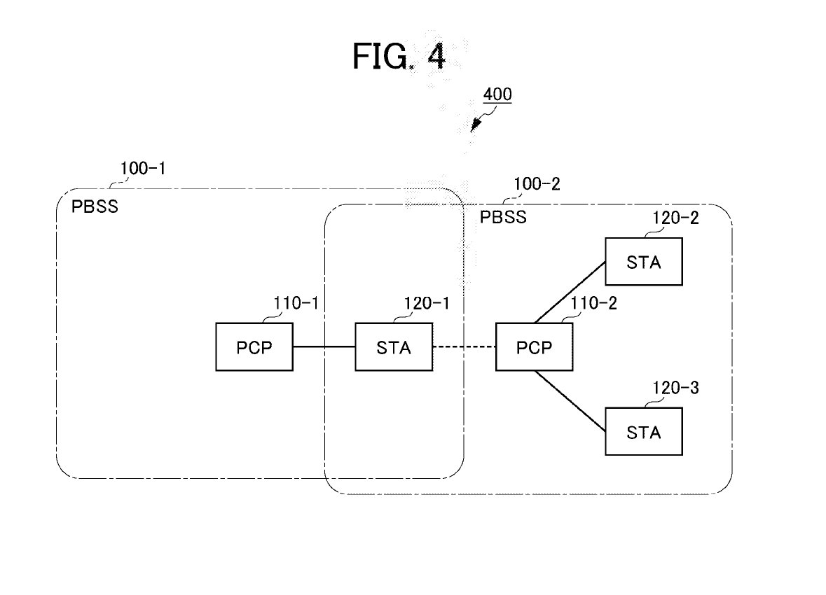

FIG. 4 is a diagram illustrating an example of a system configuration of the communication system according to one embodiment. In an example of FIG. 4, a communication system 400 includes a plurality of PCPs 110-1 and 110-2 and one or more STAs 120-1 to 120-3. In the following description, a “PCP 110” is used to indicate an arbitrary PCP among the plurality of PCPs 110-1 and 110-2. An “STA 120” is used to indicate an arbitrary STA among one or more STAs 120-1 to 120-3. The number of PCPs 110 and the number of STAs 120 illustrated in FIG. 4 are examples.

The PCPs 110-1 and 110-2 are communication devices (first communication devices) having a PCP function of the millimeter wave wireless communication system described in FIGS. 1 to 3 and form different cell PBSSs 100-1 and 100-2 in millimeter wave wireless communication (first wireless communication).

The STAs 120-1 to 12-3 are communication devices (second communication devices) having an STA function of the millimeter wave wireless communication system described in FIGS. 1 to 3 and can communicate with the PCP 110 through millimeter wave wireless communication.

In the example of FIG. 4, the PCP 110-1 forms a PBSS 100-1 which is a network cell of the millimeter wave wireless communication and transmits a beacon frame within a coverage of the PBSS 100-1. Similarly, the PCP 110-2 forms a PBSS 100-2 which is a network cell and transmits a beacon frame within a coverage of the PBSS 100-2.

In FIG. 4, a solid line connecting the STA 120-1 and the PCP 110-1 indicates a “connected” state in which the STA 120-1 is connected to the PCP 110-1 through the millimeter wave wireless communication. A broken line connecting the STA 120-1 and the PCP 110-2 indicates a “connection candidate” state in which the STA 120-1 is not connected to the PCP 110-2 through the millimeter wave wireless communication, but the STA 120-1 switches a connection destination to enter the connected state.

In other words, in FIG. 4, from a point of view from the STA 120-1, the PCP 110-1 is in the “connected” state, and the PCP 110-2 is in the “connection candidate” state. From a point of view from the STA 120-2, the PCP 110-2 is in the “connected” state, and there is no STA 120 in the “connection candidate” state. Further, from a point of view from the STA 120-3, the PCP 110-2 is in the “connected” state, and there is no STA 120 in the “connection candidate” state.

Each of the STAs 120 according to the present embodiment stores connection information including information of the PCP 110 in the “connected” state and information of the PCP 110 in the “connection candidate” state. For example, the connection information stored in each of the STAs 120 may be information which is set in advance at the time of installing the communication system or the like or may be information reported from a communication management device to be described later. Alternatively, the connection information used for the connection when the STA 120 is connected with the PCP 110 through the millimeter wave wireless communication may be stored as the connection information stored in each of the STAs 120.

In FIG. 4, when the PCP 110-1 simultaneously broadcasts predetermined data to the STAs 120-1 to 120-3 and the PCP 110-2, the PCP 110-1 transmits the predetermined data to the STA 120-1.

When the predetermined data is received from the PCP 110-1 in the “connected” state, the STA 120-1 establishes the millimeter wave wireless communication with the PCP 110-2 in the “connection candidate” state by using the previously stored connection information and transitions to the “connected” state with the PCP 110-2. The STA 120-1 transfers the predetermined data received from the PCP 110-1 to the PCP 110-2 through the millimeter wave wireless communication.

Upon receiving the predetermined data from the STA 120-1 among the STAs 120-1 to 120-3 in the “connected” state with the PCP 110-2, the PCP 110-2 transmits the received predetermined data to the other STAs 120-2 and 120-3.

For example, as described above, the PCP 110-1 can simultaneously transmit the predetermined data to the STAs 120-1 to 120-3.

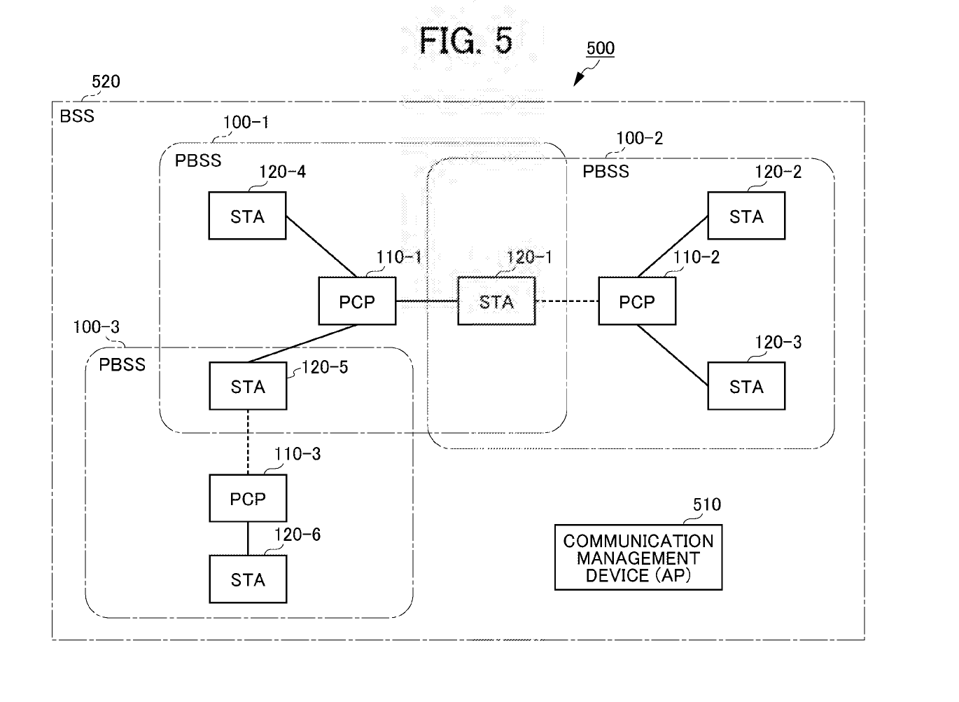

FIG. 5 is a diagram illustrating another example of the system configuration of the communication system according to one embodiment. In an example of FIG. 5, a communication system 500 includes a communication management device 510, a PCP 110-3, and a plurality of STAs 120-4 to 120-6 in addition to the configuration of the communication system 400 illustrated in FIG. 4.

The communication management device (third communication device) 510 has a function of an access point (AP) that forms a basic service set (BSS) 520 through wireless LAN communication (for example, IEEE 802.11a/b/g/n/ac or the like) having a wider communication range than the millimeter wave wireless communication. The BSS 520 is a network of an infrastructure mode by wireless LAN communication.

In the present embodiment, each of the PCPs 110-1 to 110-3 and the STAs 120-1 to 120-6 has a station function of wireless LAN communication. Accordingly, the communication management device 510 can communicate with the PCPs 110-1 to 110-3 and the STAs 120-1 to 120-6 in the BSS 520 through the wireless LAN communication (second wireless communication). The communication management device 510 manages the connection information of each of the STAs 120 in the communication system 500 and controls the communication based on the millimeter wave wireless communication.

In FIG. 5, the PCP 110-3 forms a PBSS 100-3 which is a network cell and transmits a beacon frame within a coverage of the PBSS 100-3.

In an example of FIG. 5, from a point of view from the STA 120-5, the PCP 110-1 is in the “connected” state, and the PCP 110-3 is in the “connection candidate” state. Similarly, from a point of view from the STA 120-4, the PCP 110-1 is in the “connected” state, and from a point of view from the STA 120-6, the PCP 110-3 is in the “connected” state.

As described above, the PCP 110 and the STA 120 can be added to the communication system 500 according to the present embodiment to expand the communication area based on the millimeter wave wireless communication.

Preferably, the communication system 500 can communicate with each of the PCP 110 and the STA 120 included in the communication system 500 and includes the communication management device 510 that performs management of the connection information, control of communication, and the like. A specific functions and process of the communication management device 510 will be described later.

<Hardware Configuration>

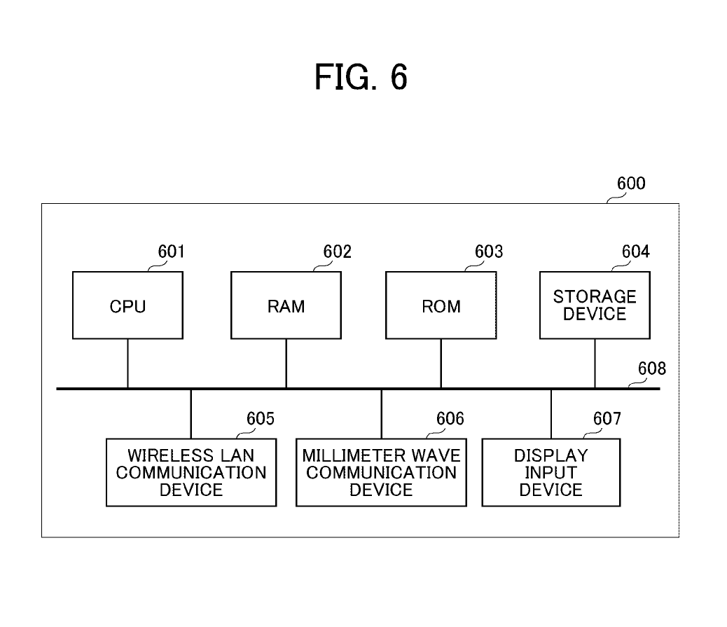

FIG. 6 is a hardware configuration diagram of the communication device according to one embodiment.

(Hardware Configuration of Each of PCP and STA)

Each of the PCP 110 and the STA 120 have, for example, a hardware configuration of a communication device 600 illustrated in FIG. 6.

As illustrated in FIG. 6, the communication device 600 has a configuration of a general computer and includes, for example, a Central Processing Unit (CPU) 601, a Read Only Memory (RAM) 602, a Read Only Memory (ROM), a storage device 604, a wireless LAN communication device 605, a millimeter wave communication device 606, a display input device 607, a bus 608, and the like.

The CPU 601 is an operation device that implements the functions of the communication device 600 by reading out a program and data stored in the ROM 603, the storage device 604, or the like onto the RAM 602 and performing a process. The RAM 602 is a volatile memory used as a work area or the like of the CPU 601. The ROM 603 is a non-volatile memory capable of holding a program and data even when the power is turned off.

The storage device 604 is a storage device such as a hard disk drive (HDD), a solid state drive (SSD), a flash ROM, or the like, and stores an operation system (OS), an application program, various data, and the like.

The wireless LAN communication device 605 is a wireless communication device that performs the wireless LAN communication such as IEEE802.11a/b/g/n/ac, and includes, for example, an antenna, a radio unit, a media access control (MAC) unit, and the like.

The millimeter wave communication device 606 is, for example, a wireless communication device that performs the millimeter wave wireless communication such as IEEE802.11ad and includes, for example, an antenna, a radio unit, a MAC unit, and the like.

The display input device 607 includes a display device that performs display, an input device that receives an input, and the like. The bus 608 is connected to each of the above-mentioned components and transmits an address signal, a data signal, various kinds of control signals, and the like.

(Hardware Configuration of Communication Management Device)

As an example, the communication management device 510 has a hardware configuration in which the millimeter wave communication device 606 is excluded from the hardware configuration of the communication device 600 illustrated in FIG. 6. In other words, the communication management device 510 has a CPU 601, a RANI 602, a ROM 603, a storage device 604, a wireless LAN communication device 605, and a display input device 607.

As another example, the communication management device 510 has the functional configuration of the communication device 600 illustrated in FIG. 6. In this case, the communication management device 510 can implement the function of the communication management device 510 and functions as one of the PCP 110 or the STA 120 to perform the millimeter wave wireless communication.

The hardware configuration of the communication device 600 illustrated in FIG. 6 is an example. For example, the communication device 600 may further have a communication interface or the like for a connection with an external network.

<Functional Configuration>

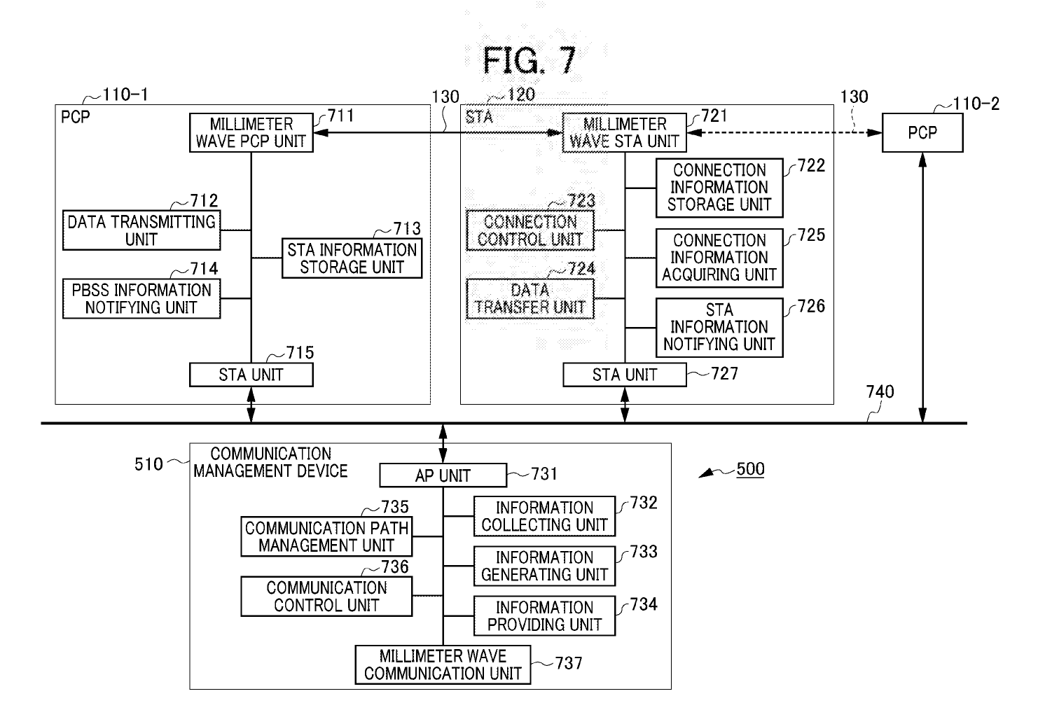

FIG. 7 is a diagram illustrating exemplary functional configurations of the communication devices included in the communication system according to one embodiment. In FIG. 7, in a communication system 500, the plurality of PCPs 110-1 and 110-2, the STA 120, and the communication management device 510 are connected to be able to perform communication via a wireless LAN network (second wireless communication) 740.

(Functional Configuration of PCP)

In FIG. 7, the PCP 110-2 has the same functional configuration as the PCP 110-1. In the following description, a “PCP 110” is used to indicate an arbitrary PCP of the PCPs 110-1 and 110-2.

The first communication device (PCP) 110 has a millimeter wave PCP unit 711, a data transmitting unit 712, an STA information storage unit 713, a PBSS information notifying unit 714, and an STA unit 715.

The millimeter wave PCP unit 711 enables the PCP 110 to function as the PBSS central point (PCP) of the millimeter wave wireless communication system described in FIGS. 1 to 3. The millimeter wave PCP unit 711 is implemented by, for example, a program executed by the millimeter wave communication device 606 in FIG. 6 and the CPU 601 in FIG. 6.

The millimeter wave PCP unit 711 forms the PBSS (network cell) through the millimeter wave wireless communication (first wireless communication) 130 and transmits a predetermined beacon. The millimeter wave PCP unit 711 performs a connection process for performing the millimeter wave wireless communication 130 with the STA 120 and performs transmission and reception of data. Examples of the connection process for the millimeter wave wireless communication 130 may include a process of generating an encryption key used for communication, a process of setting an IP address, and the like.

When the millimeter wave PCP unit 711 receives data from one STA 120 included in the PBSS, the data transmitting unit 712 transmits (transfers) the received data to another STA included in the PBSS. The data transmitting unit 712 is implemented, for example, by a program performed by the CPU 601 in FIG. 6. The function of the data transmitting unit 712 may be implemented by the millimeter wave PCP unit 711.

The STA information storage unit (first storage unit) 713 is a unit that stores information of the STA included in the PBSS formed by the PCP 110. The STA information storage unit 713 is implemented by, for example, the RAM 602 in FIG. 6, the storage device 604, and a program executed by the CPU 601 in FIG. 6.

For example, the STA information storage unit 713 stores information such as an encryption key, a MAC address, and an IP address used when the millimeter wave PCP unit 711 performs communication with the STA 120. Alternatively, the STA information storage unit 713 may store the information of the STA 120 reported from the communication management device 510.

The PBSS information notifying unit 714 is a unit that notifying the communication management device 510 or the like of information of the PBSS formed by the PCP 110 through the wireless LAN communication and is implemented by, for example, a program executed by the CPU 601 in FIG. 6. The information of the PBSS includes information such as a channel number (an example of channel information) used by the millimeter wave PCP unit 711 of the PCP 110, identification information of the PBSS (for example, a MAC address of the PCP 110 or the like), and the like.

The STA unit 715 enables the PCP 110 to function as an STA of the wireless LAN communication. The STA unit 715 is implemented by, for example, the wireless LAN communication device 605 in FIG. 6 and the program executed by the CPU 601 in FIG. 6.

For example, the STA unit 715 receives the beacon transmitted from the communication management device 510, establishes the wireless LAN communication with the communication management device 510, and connects the PCP 110 to the wireless LAN network 740.

Through the above configuration, the PCP 110 forms the PBSS (network cell) through the millimeter wave wireless communication (first wireless communication) and is configured to be able to communicate with the communication management device 510 and the like through the wireless LAN communication (second wireless communication).

(Functional Configuration of STA)

The STA 120 includes a millimeter wave STA unit 721, a connection information storage unit 722, a connection control unit 723, a data transfer unit 724, a connection information acquiring unit 725, an STA information notifying unit 726, and an STA unit 727.

The millimeter wave STA unit 721 enables the station (STA) 120 to function as the STA of the millimeter wave wireless communication system described in FIGS. 1 to 3. The millimeter wave STA unit 721 is implemented by, for example, the millimeter wave communication device 606 in FIG. 6 and a program executed by the CPU 601 in FIG. 6.

For example, the millimeter wave STA unit 721 performs the connection process with the PCP 110-1 or the PCP 110-2 through the millimeter wave wireless communication 130 and performs transmission and reception of data with the connected PCP 110. Examples of the connection process for the millimeter wave wireless communication 130 may include a process of scanning the PCP 110, a process of generating an encryption key, a process of setting an IP address, and the like.

The connection information storage unit (second storage unit) 722 stores connection information for a connection with a plurality of PCPs (first communication devices) 110-1 and 110-2 through the millimeter wave wireless communication (first wireless communication). The connection information storage unit 722 is implemented by, for example, the RAM 602 in FIG. 6, the storage device 604, and a program executed by the CPU 601 in FIG. 6.

For example, the connection information includes information indicating that the PCP 110-1 is in the “connected” state, information indicating that the PCP 110-2 is in the “connection candidate” state, and the like as described in FIG. 4. Further, the connection information may include various information for a connection with the PCPs 110-1 and 110-2 (for example, the identification information of the PBSS, the channel information, the sector information, the encryption key, the IP address, and the like). The connection information storage unit 722 is an example of a connection information management unit that manages the connection information used for the STA 120 to establish a connection with the PCP 110 through the millimeter wave wireless communication.

When data is received from one PCP 110 among the plurality of PCPs 110-1 and 110-2, the connection control unit 723 establishes the millimeter wave wireless communication 130 with another PCP 110 different from one PCP 110 using the connection information stored in the connection information storage unit 722. The connection control unit 723 is implemented, for example, by a program executed by the CPU 601 in FIG. 6.

For example, when data is received from the PCP 110-1 in the “connected” state, the connection control unit 723 disconnects the millimeter wave wireless communication 130 with the PCP 110-1 and establishes the millimeter wave wireless communication 130 with the PCP 110-2 in the “connection candidate” state.

The data transfer unit 724 transfers the data received from one PCP 110 to another PCP 110 with which the connection control unit 723 has established the millimeter wave wireless communication 130. The data transfer unit 724 is implemented, for example, by a program executed by the CPU 601 in FIG. 6.

The connection information acquiring unit 725 acquires the connection information reported from the communication management device 510 through the wireless LAN communication and stores the acquired connection information in the connection information storage unit 722. The connection information acquiring unit 725 is implemented, for example, by a program executed by the CPU 601 in FIG. 6.

The STA information notifying unit 726 is a unit that notifies the communication management device 510 or the like of the information of the STA 120 via the wireless LAN network 740 and is implemented by, for example, a program executed by the CPU 601 in FIG. 6. The information of the STA 120 of which the STA information notifying unit 726 notifies the communication management device 510 or the like includes, for example, some or all of the connection information stored in the connection information storage unit 722.

The STA unit 727 enables the STA 120 to function as the STA of the wireless LAN communication. The STA unit 727 is implemented by, for example, the wireless LAN communication device 605 in FIG. 6 and a program executed by the CPU 601 in FIG. 6.

For example, the STA unit 727 receives the beacon transmitted from the communication management device 510, establishes the wireless LAN communication with the communication management device 510, and connects the STA 120 to the wireless LAN network 740.

Through the above configuration, the STA 120 is able to communicate with the PCP 110 through the millimeter wave wireless communication (first wireless communication) and configured to be able to communicate with the communication management device 510 and the like through the wireless LAN communication (second wireless communication).

(Functional Configuration of Communication Management Device)

The communication management device 510 has an AP unit 731, an information collecting unit 732, an information generating unit 733, an information providing unit 734, a communication path management unit 735, and a communication control unit 736.

Preferably, the communication management device 510 further includes a millimeter wave communication unit 737.

The AP unit 731 enables the communication management device 510 to function as the access point (AP) of the wireless LAN communication. The AP unit 731 is implemented by, for example, the wireless LAN communication device 605 in FIG. 6 and a program executed by the CPU 601 in FIG. 6.

For example, the AP unit 731 provides the BSS 520 which is the wireless LAN network 740 of the infrastructure mode through the wireless LAN communication (for example, IEEE 802.11 a/b/g/n/ac or the like).

The information collecting unit 732 collects PBSS information (for example, identification information, channel information, encryption key information, destination information, and the like of PBSS 100) formed by each PCP 110 from the plurality of PCPs 110 using the wireless LAN network 740 provided by the AP unit 731.

Further, the information collecting unit 732 collects the connection information of the STA 120 (for example, some or all of the connection information stored in the connection information storage unit 722 and the like) from one or more STAs 120 using the wireless LAN network 740 provided by the AP unit 731. The information collecting unit 732 is implemented by, for example, a program executed by the CPU 601 in FIG. 6.

The information generating unit 733 is a unit that generates information to be provided to each of the PCPs 110, each of the STAs 120, and the like on the basis of the information collected by the information collecting unit 732 and is implemented, for example, by a program executed by the CPU 601 in FIG. 6.

For example, the information generating unit 733 may generate information to be provided to one or more STAs 120 (for example, some or all of the connection information stored in the connection information storage unit 722) on the basis of the PBSS information collected from the plurality of PCPs 110 by the information collecting unit 732.

Further, the information generating unit 733 generates information to be provided to the plurality of PCPs 110 (for example, some of all of the STA information stored in the STA information storage unit 713) on the basis of the connection information of the STAs 120 or the like collected from one or more STAs 120 by the information collecting unit 732.

The information providing unit 734 is a unit that provides the information generated by the information generating unit 733 to the PCP 110, the STA 120, and the like using the wireless LAN network 740 and is implemented by a program executed by the CPU 601 in FIG. 6.

For example, as illustrated in FIG. 5, the communication path management unit 735 manages communication path information including information of the plurality of PCPs 110 and one or more STAs 120 included in the communication system 500 and information of a communication path (network topology). The communication path management unit 735 is implemented, for example, by a program executed by the CPU 601 in FIG. 6, a storage device 604, and the like.

For example, the communication path management unit 735 stores the communication path information set by the administrator or the like in the storage device 604 or the like in advance. Alternatively, the communication path management unit 735 may analyze the communication path information of the communication system 500 using the PBSS information collected by the information collecting unit 732, the connection information of the STA 120, and the like and store an analysis result in the storage device 604 or the like.

The communication control unit 736 is a unit that controls the millimeter wave wireless communication in the communication system 500 and is implemented by, for example, a program executed by the CPU 601 in FIG. 6.

For example, in the communication system 500 illustrated in FIG. 5, the PCP 110-1 transmits data to the STAs 120-1, 120-4, and 120-5, so that data can be simultaneously transmitted to the PCPs 110-2 and 110-3 and the STAs 120-1 to 120-6.

On the other hand, the PCP 110-2 is unable to simultaneously transmit data to other communication devices unless the connection destination of the STA 120-1 is switched to the PCP 110-2.

In this regard, for example, when a transmission initiation request indicating that data is simultaneously transmitted is received from the PCP 110-2, the communication control unit 736 gives an instruction to switch the connection destination to the STA 120-1 on the basis of the communication path information managed by the communication path management unit 735.

As described above, when a communication initiation request is received from the PCP 110 or the STA 120, the communication control unit 736 gives an instruction to switch the connection destination required for initiation of communication to the STA 120 on the basis of the communication path information managed by the communication path management unit 735. The communication control unit 736 notifies each of the PCPs 110 of a data transmission destination as appropriate.

The millimeter wave communication unit 737 is implemented by, for example, the millimeter wave communication device 606 in FIG. 6 and a program executed by the CPU 601 in FIG. 6. The millimeter wave communication unit 737 implements the millimeter wave communication function of the PCP 110 or the STA 120, for example, through a setting or the like by an administrator.

For example, when an administrator or the like performs a setting in the PCP 110, the millimeter wave communication unit 737 functions as the millimeter wave PCP unit 711, the data transmitting unit 712, and the like in FIG. 7. Further, when an administrator or the like performs a setting in the STA 120, the millimeter wave communication unit 737 functions as the millimeter wave STA unit 721, the connection control unit 723, the data transfer unit 724, and the like in FIG. 7.

Thus, for example, in the communication system 500 illustrated in FIG. 5, the communication management device 510 can function as the communication management device 510 and function as any one of the PCP 110-1 to PCP 110-3 or any one of the STAs 120-1 to 120-6.

Through the above configuration, the communication management device 510 collects information of the communication system 500 from the PCP 110, the STA 120, and the like using the wireless LAN network 740 and provides requisite information to the PCP 110, the STA 120, and the like. The communication management device 510 is another example of the connection information management unit that manages the connection information used for the STA 120 to be connected to the PCP 110 through the millimeter wave wireless communication.

The communication management device 510 manages the communication path information of the communication system 500 and performs requisite communication control in response to the communication initiation request from the PCP 110, the STA 120, or the like.

<Flow of Process>

Next, the flow of a process of a communication control method in the communication system 500 will be described.

### First Embodiment

First, the flow of a basic communication process in the communication system 400 will be described with reference to the communication system 400 illustrated in FIG. 4.

(Connection Information)

Each of the STAs 120 according to the present embodiment is assumed to be in “connected” state with one PCP 110 through the millimeter wave wireless communication. The STA 120 can perform transmission and reception of data with the PCP 110 in the “connected” state through the millimeter wave wireless communication.

There are cases in which the STA 120 is in the “connection candidate” state with another PCP 110 different from the PCP 110 connected through the millimeter wave wireless communication. In this case, the STA 120 disconnects (stops or suspends) communication with the PCP 110 in the “connected” state and establishes (initiates) communication with another PCP 110 in the “connection candidate” state, so that transmission and reception of data with the other PCP 110 can be performed.

The STA 120 according to the present embodiment stores in the connection information storage unit 722 connection information including information on the PCP 110 in the “connected” state, information on the PCP 110 in the “connection candidate” state, and the like.

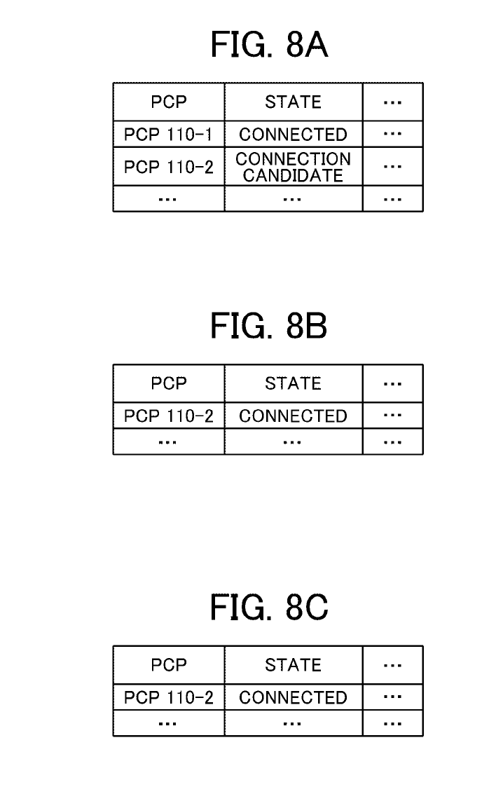

FIGS. 8A to 8C are diagrams illustrating an example of the connection information stored in the STA according to the first embodiment. In an example of FIGS. 8A to 8C, the connection information stored in each of the STAs 120 includes information of a “PCP” and a “state.”

The “PCP” is information specifying the PCP 110 such as an identification name, an identification number, identification information, or the like of the PCP 110. The “state” is information indicating whether or not the STA 120 is in the “connected” state or the “connection candidate” state with each of the PCPs 110.

In the example of FIG. 4, since the STA 120-1 is in the “connected” state with the PCP 110-1 and in the “connection candidate” state with the PCP 110-2, connection information illustrated in FIG. 8A is stored in the connection information storage unit 722 of the STA 120-1. Since the STA 120-2 is in the “connected” state with the PCP 110-1, and there is no PCP 110 in the “connection candidate” state, connection information illustrated in FIG. 8B is stored in the connection information storage unit 722 of the STA 120-2. Similarly, since the STA 120-3 is in the “connected” state with the PCP 110-1, and there is no PCP 110 in the “connection candidate” state, connection information illustrated in FIG. 8C is stored in the connection information storage unit 722 of the STA 120-3.

For example, the connection information illustrated in FIGS. 8A to 8C is set by an administrator (or an installer or the like) at the time of installing the communication system 500 or the like. As another example, a notification of the connection information illustrated in FIGS. 8A to 8C may be given from the communication management device 510 via the wireless LAN network 740.

(Communication Process)

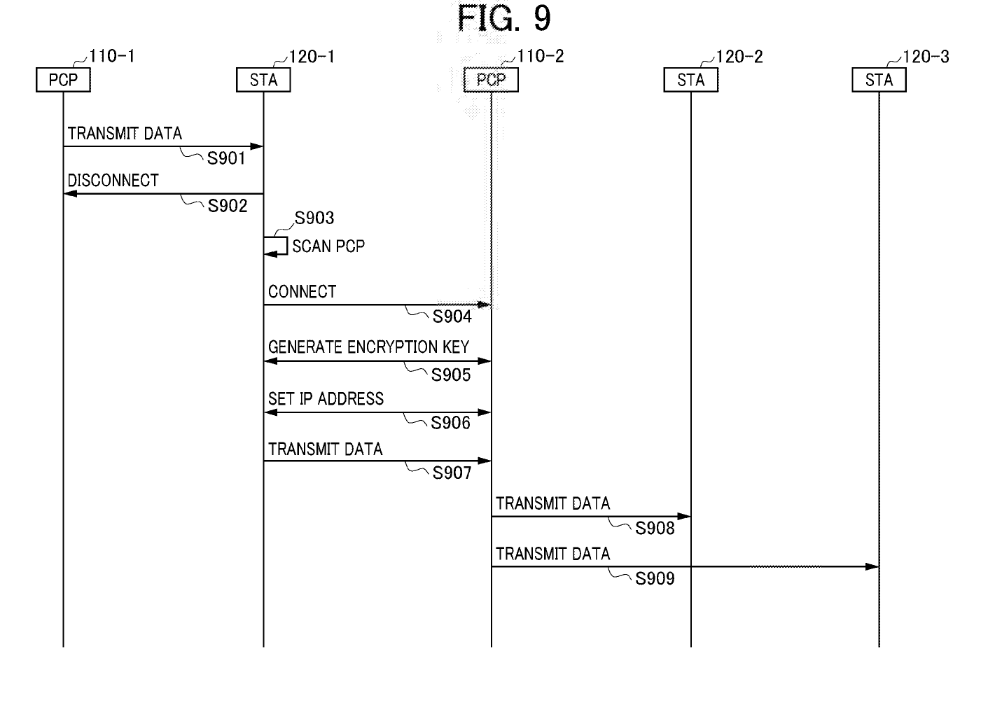

FIG. 9 is a sequence diagram illustrating an example of a communication process according to the first embodiment. A sequence diagram of FIG. 9 illustrates an example of a communication process when the PCP 110-1 simultaneously transmits predetermined data to the STAs 120-1 to 120-3 and the PCP 110-2 in the communication system 400 illustrated in FIG. 4.

In step S901, the millimeter wave PCP unit 711 of the PCP 110-1 simultaneously transmits the predetermined data to the STA 120 connected to the PBSS 100-1 formed by the PCP 110-1 through the millimeter wave wireless communication. In the example of FIG. 4, since the STA 120 connected to the PBSS 100-1 is only the STA 120-1, the predetermined data is transmitted to the STA 120-1.

In step S902, the connection control unit 723 of the STA 120-1 that has received the predetermined data from the PCP 110-1 performs a disconnection process for the millimeter wave wireless communication with the PCP 110-1 that has transmitted the predetermined data. Accordingly, the STA 120-1 can establish the millimeter wave wireless communication with the PCP 110-2 in the “connection candidate” state.

In step S903, the millimeter wave STA unit 721 of the STA 120-1 scans the PCP 110 and extracts the PCP 110 that is transmitting the beacon of the millimeter wave wireless communication around the STA 120-1. For example, in the communication system 500, for example, when three channels are permitted to be used, the millimeter wave STA unit 721 of the STA 120-1 sequentially scans the three channels.

In step S904, when the PCP 110-2 in the “connection candidate” state is discovered by the scanning of the PCP 110 in step S903, the connection control unit 723 of the PCP 110-1 performs a connection process for the millimeter wave wireless communication with the PCP 110-2.

In step S905, the connection control unit 723 of the PCP 110-1 performs a process of generating an encryption key for encrypting communication data with the PCP 110-2.

In step S906, the connection control unit 723 of the PCP 110-1 performs a process of setting an IP address with the PCP 110-2. For example, the connection control unit 723 of the PCP 110-1 acquires an IP address allocated from the PCP 110-2.

In step S907, when the connection process with the PCP 110-2 is completed, the data transfer unit 724 of the STA 120-1 transmits (transfers) the predetermined data received from the PCP 110-1 in step S901 to the PCP 110-2.

In steps S908 and S909, when the predetermined data is received from the STA 120-1, the data transmitting unit 712 of the PCP 110-2 transmits the predetermined data to the STAs 120-2 and 120-3 connected to the PBSS 100-2 formed by the PCP 110-2.

Through the above processing, the communication system 500 according to the present embodiment can combine the communication devices (the PCP 110 and the STA 120) that perform communication with the one-to-one or star-type network configuration and perform hopping communication to different network cells.

### Second Embodiment

In the communication process according to the first embodiment illustrated in FIG. 9, the process of scanning the PCP 110 has been described as being performed, for example, through the three channels in step S903. As described above, when the process of scanning the PCP 110 of three channels is performed, for example, a time of about 750 ms may be required.

A second embodiment will be described in connection with an example of a communication process of reducing the time required for the process of scanning the PCP 110 in the communication process according to the first embodiment.

(Connection Information)

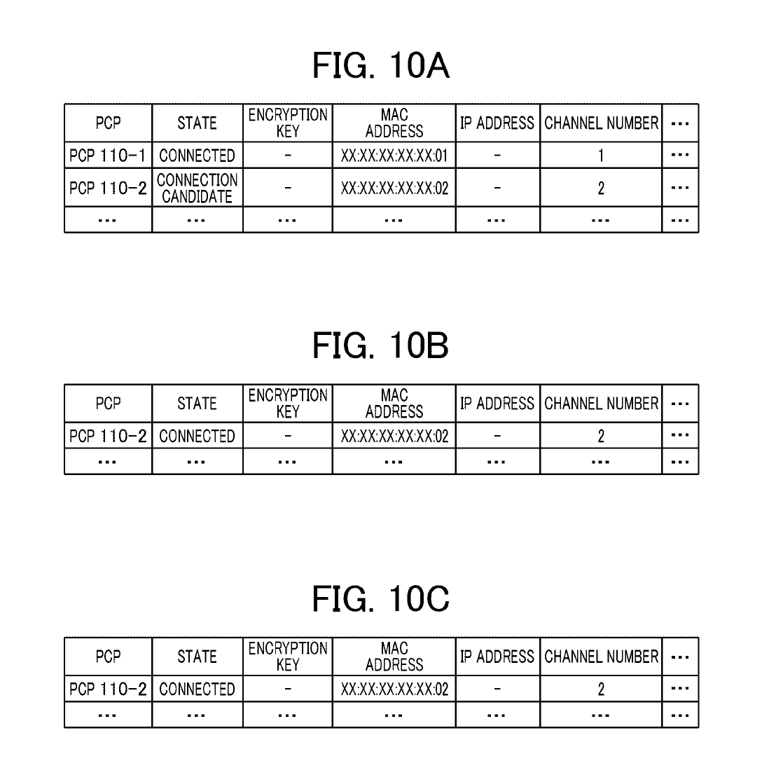

FIGS. 10A to 10C are diagrams illustrating an example of the connection information stored in the STA according to the second embodiment. As illustrated in FIGS. 10A to 10C, information such as an “MAC address,” a “channel number,” and the like are stored in the connection information according to the present embodiment in addition to the connection information of the first embodiment illustrated in FIGS. 8A to 8C.

The “MAC address” is the MAC address of the PCP 110 and is an example of the identification information identifying the PBSS which is formed by the PCP 110 or the PCP 110 through the millimeter wave wireless communication. The “channel number” is information indicating the channel number which is used by the PCP 110 in the millimeter wave wireless communication.

For example, the information of the “MAC address” and the “channel number” is an example of information acquired through the process of scanning the PCP 110. For example, the STA 120 according to the present embodiment stores the information of the “MAC address” and the “channel number” acquired through the PCP scanning process in the connection information storage unit 722.

(Communication Process)

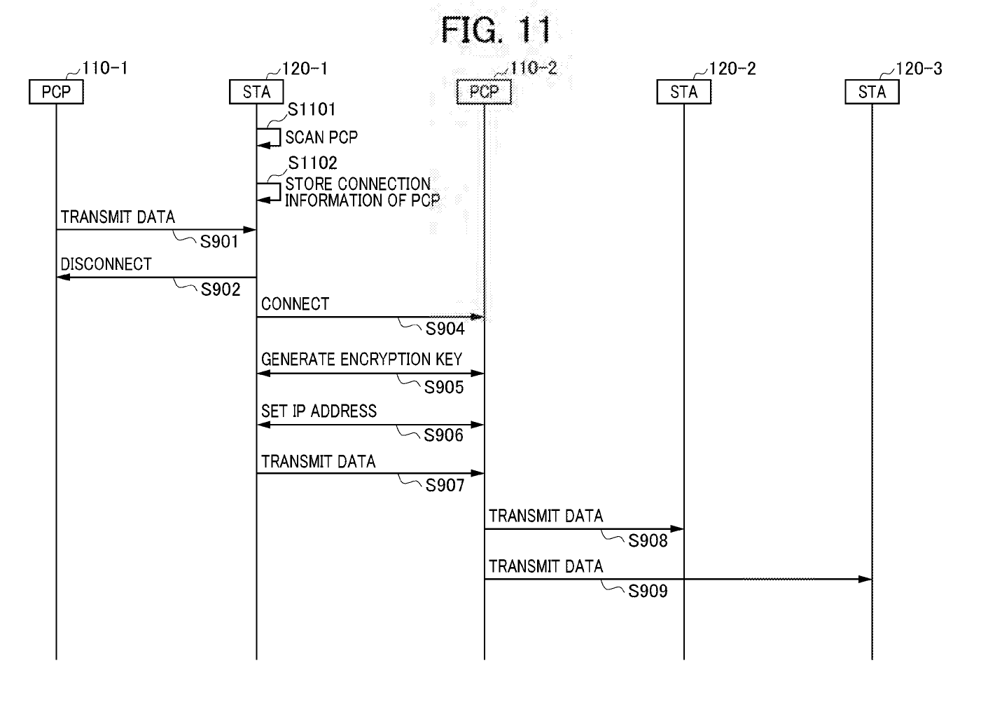

FIG. 11 is a sequence diagram illustrating an example of a communication process according to the second embodiment.

In step S1101, the millimeter wave STA unit 721 of the STA 120-1 performs the process of scanning the PCP 110, for example, at predetermined time intervals. Through this process, the information such as the MAC address and the channel number of the PCP 110 around the STA 120-1 is acquired.

In step S1102, the STA 120-1 stores the information such as the MAC address and the channel number of the PCP 110 acquired in step S1101 in the connection information storage unit 722.

Preferably, the STA 120-1 stores the information of the PCP 110-1 in the “connected” state and the information of the PCP 110-2 in the “connection candidate” state among the acquired information such as the MAC address and the channel number of the PCP 110 in the connection information storage unit 722. Through this process, for example, the connection information as illustrated in FIG. 10A is stored in the connection information storage unit 722 of the STA 120-1.

The STA 120-1 according to the present embodiment performs the communication process from step S901, for example, using the connection information illustrated in FIG. 10A. The process of steps S901, S902, and S904 to S900 in FIG. 11 are similar to the communication process according to the first embodiment illustrated in FIG. 9.

The millimeter wave STA unit 721 of the STA 120-1 according to the present embodiment omits the PCP scanning process of step S903 in the communication process illustrated in FIG. 9 using the information such as the MAC address and the channel number of the PCP 110-2 stored in the connection information storage unit 722.

For example, the millimeter wave STA unit 721 of the STA 120-1 performs the disconnection process for the PCP 110-1 in step S902 of FIG. 11 and then performs the process from step S904 without performing the process of scanning the PCP 110.

Accordingly, in the communication system 400 according to the present embodiment, since it is possible to omit the process of step S903 in the communication process according to the first embodiment illustrated in FIG. 9, the predetermined data received from the PCP 110-1 can be transferred to the PCP 110-2 more rapidly. For example, the STA 120-1 can reduce the time required for the connection process in which the STA 120-1 is connected to the PCP 110-2 by about 250 ms to 750 ms required for the scanning of the PCP 110.

### Third Embodiment

In the second embodiment, the STA 120-1 scans the PCP 110 in advance and acquires the connection information of the PCP 110-2 in the “connection candidate” state. A third embodiment will be described in connection with an example in which the connection information of the PCP 110-2 is stored in the connection information storage unit 722 when the STA 120-1 is connected to the PCP 110-2 in the “connection candidate” state.

(Connection Information)

In the present embodiment, the STA 120-1 stores (caches) the connection information used in the millimeter wave wireless communication (for example, the encryption key, the MAC address, the IP address, the channel number, or the like) when performing the millimeter wave wireless communication with the PCP 110 in the connection information storage unit 722.

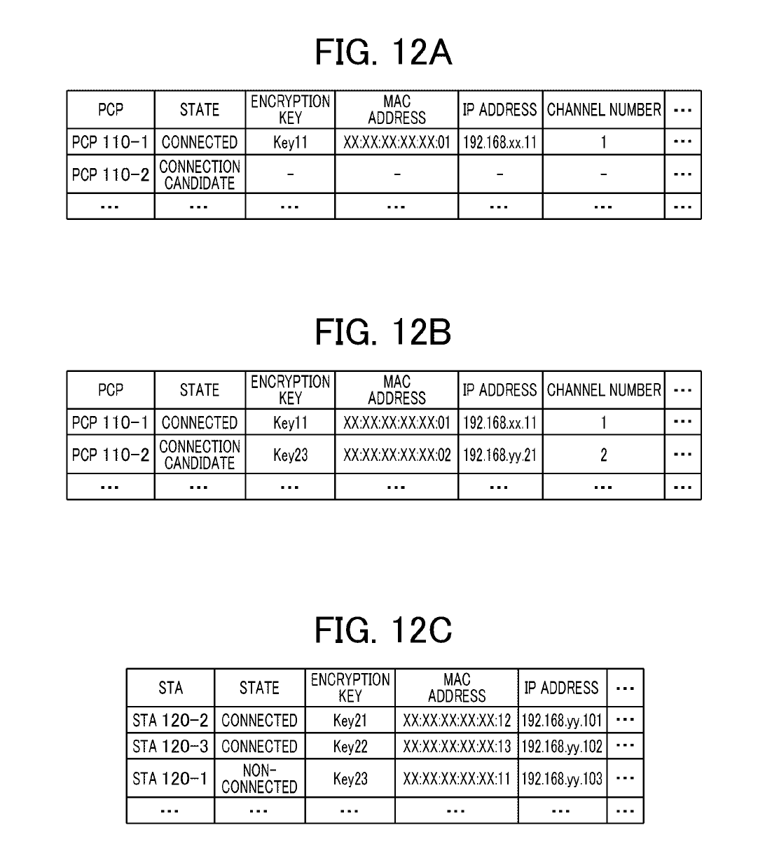

FIG. 12A illustrates an example of the connection information stored in the connection information storage unit 722 of the STA 120-1 before the STA 120-1 performs the millimeter wave wireless communication with the PCP 110-2 in the communication system 400 illustrated in FIG. 4.

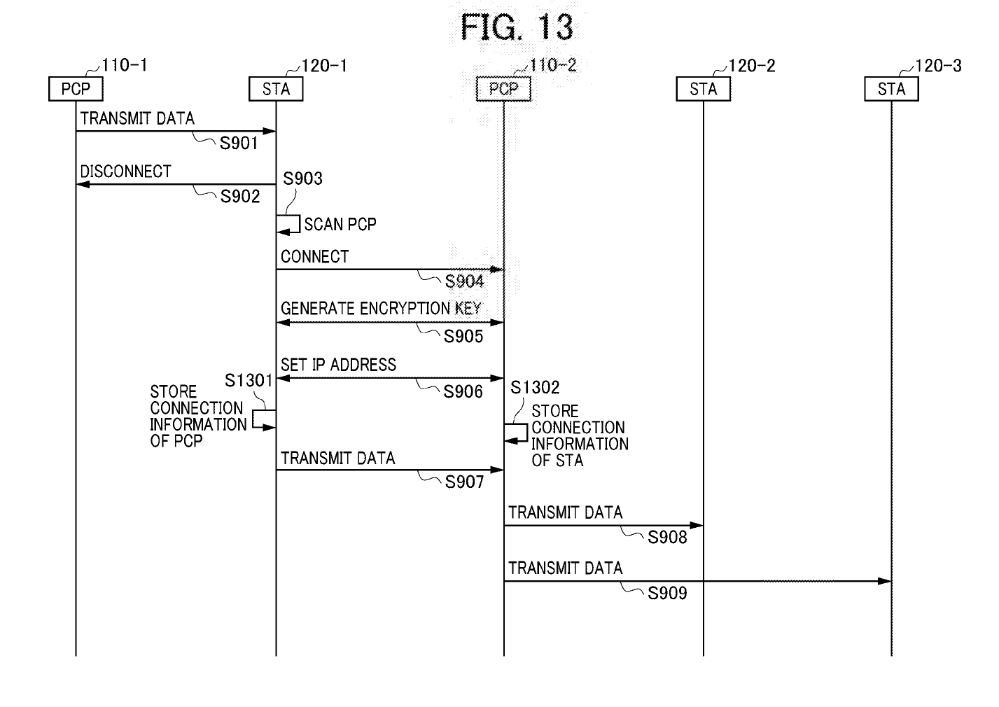

In an example of FIG. 12A, the information such as the encryption key, the MAC address, the IP address, and the channel of the PCP 110-1 which is in the connected state through the millimeter wave wireless communication is stored in connection information stored in the STA 120-1. On the other hand, the information such as the encryption key, the MAC address, the IP address, the channel, and the like of the PCP 110-2 that has not been in communication yet is not stored in the connection information stored in the STA 120-1. In this case, for example, a communication process as illustrated in FIG. 13 is performed in the communication system 400.

FIG. 12B illustrates an example of the connection information stored in the connection information storage unit 722 of the STA 120-1 after the STA 120-1 performs the millimeter wave wireless communication with the PCP 110-2 in the communication system 400 illustrated in FIG. 4.

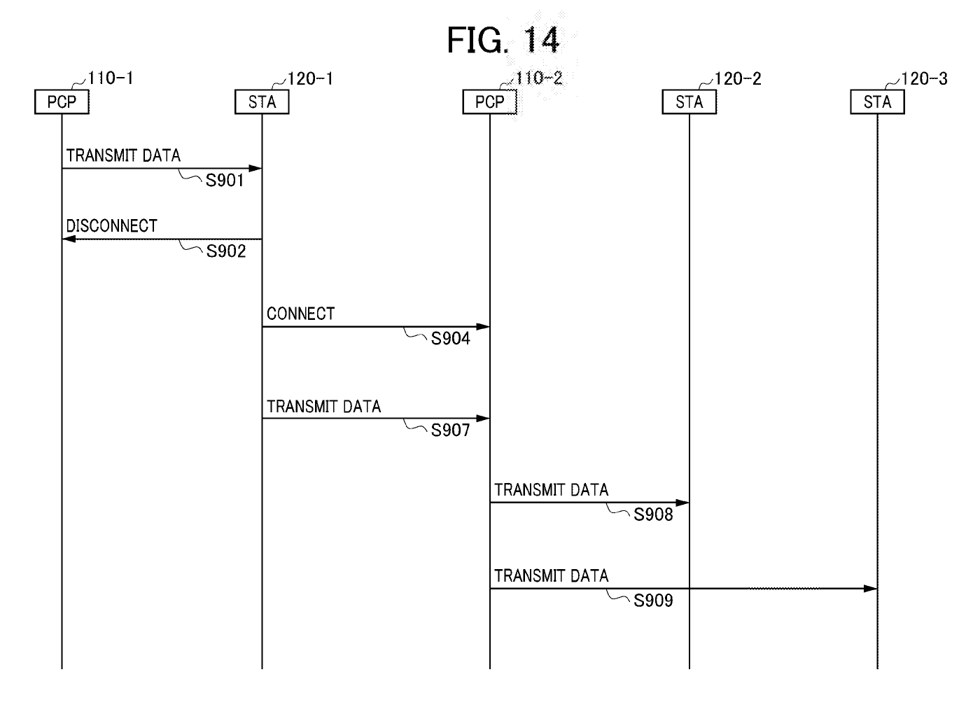

In an example of FIG. 12B, the information such as the encryption key, the MAC address, the IP address, the channel, or the like of the PCP 110-2 is stored. In this case, for example, a communication process illustrated in FIG. 14 is performed in the communication system 400.

Preferably, as illustrated in FIG. 12C, on the PCP 110 side also the STA information storage unit 713 stores the STA information of the STA 120. In an example of FIG. 12C, information such as an “STA,” a “state,” an “encryption key,” a “MAC address,” an “IP address,” and the like is stored in the STA information stored in the PCP 110-2.

The “STA” is information specifying the STA 120-2 or 120-3 connected to the PBSS 100-2 formed by the PCP 110-2, the STA 120-1 connected to the PBSS 100-2, or the like (an identification name, identification information, or the like).

The “state” is information indicating whether or not each of the STAs 120 is connected to the PBSS 100-2 formed by the PCP 110-2. The “encryption key” is information of an encryption key used for the millimeter wave wireless communication with each of the STAs 120. The “MAC address” is a MAC address of each of the STAs 120. The “IP address” is information of an IP address used for the millimeter wave wireless communication with each of the STAs 120.

(Communication Process)

FIGS. 13 and 14 are sequence diagrams illustrating an example of a communication process according to the third embodiment.

FIG. 13 illustrates an example of the communication process before the STA 120-1 communicates with the PCP 110-2 in the “connection candidate” state. Since the process of steps S901 to S906 and S907 to 909 in FIG. 13 is similar to the communication process according to the first embodiment illustrated in FIG. 9, description will proceed focusing on a difference with the communication process according to the first embodiment.

In steps S901 to S906, the STA 120-1 that has received data from the PCP 110-1 performs the disconnection process for the millimeter wave wireless communication with the PCP 110-1, and performs the connection process for the millimeter wave wireless communication with the PCP 110-2.

In step S1301, the STA 120-1 stores the information such as the MAC address and the channel number of the PCP 110-2 and the connection information such as the encryption key, the IP address, and the like used for performing the millimeter wave wireless communication with the PCP 110-2 in the connection information storage unit 722. Accordingly, for example, the connection information as illustrated in FIG. 12B is stored in the connection information storage unit 722 of the STA 120-1.

FIG. 14 illustrates an example of a communication process after the STA 120-1 communicates with the PCP 110-2 in the “connection candidate” state. Since the process of steps S901, S902, S904, and S907 to 909 in FIG. 14 is similar to the communication process according to the first embodiment illustrated in FIG. 9, description will proceed focusing a difference with the communication process according to the first embodiment.

In the communication process illustrated in FIG. 14, the PCP scanning process in step S903, the process of generating the encryption key in step S906, the process of setting the IP address in step S906, and the like in the communication processes according to the first embodiment are omitted. Since such items of information are already stored, for example, in the connection information illustrated in FIG. 12B, the millimeter wave STA unit 721 of the STA 120-1 omits the procedures using the stored connection information, and performs the connection process for the millimeter wave wireless communication with the PCP 110-2.

Since the encryption key, the IP address, and the like used for the millimeter wave wireless communication with the STA 120-1 are stored even in the PCP 110-2 side as indicated in the STA information in FIG. 12C, the data communication can be performed between the STA 120-1 and the PCP 110-2.

In the present embodiment, for example, it is possible to reduce the time required for a connection to the PCP 110 by about 250 ms to 750 ms when the process of scanning the PCP 110 is omitted, about 20 ms when the process of generating the encryption key is omitted, and about 2 to 4 seconds when the process of setting the IP address is omitted.

### Fourth Embodiment

In the first embodiment to the third embodiment, the flow of the basic communication process in the communication system 400 has been described with reference to the communication system 400 illustrated in FIG. 4. In the fourth embodiment, a more specific process of the communication system 500 will be described with reference to the communication system 500 illustrated in FIG. 5.

(Information Provision Process)

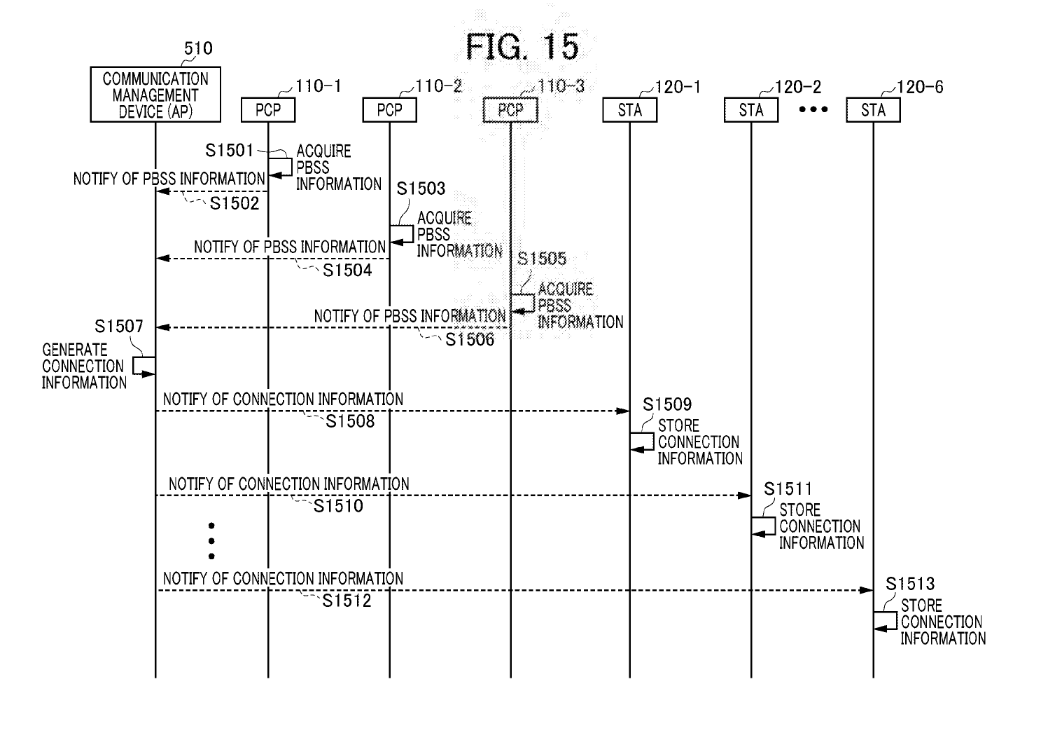

FIG. 15 is a sequence diagram illustrating an example of an information provision process according to the fourth embodiment. In a sequence diagram illustrated in FIG. 15, broken arrows indicate the flow of data and information according to the wireless LAN communication.

In step S1501, the PBSS information notifying unit 714 of the PCP 110-1 acquires the PBSS information of the PBSS 100-1 formed by the PCP 110-1, for example, at predetermined time intervals or the like. At this time, the PBSS information acquired by the PBSS information notifying unit 714 includes, for example, the MAC address of the PCP 110-1, the channel number of the millimeter wave wireless communication used by the PCP 110-1, the IP address of the STA 120 belonging to the PBSS 100-1, and the like.

In step S1502, the PBSS information notifying unit 714 of the PCP 110-1 gives a notification of the PBSS information of the PBSS 100-1 acquired in step S1501 to the communication management device 510 via the wireless LAN network 740.

In step S1503, similarly to the PCP 110-1, the PCP 110-2 acquires the PBSS information of the PBSS 100-2 formed by the PCP 110-2.

In step S1504, the PBSS information notifying unit 714 of the PCP 110-2 gives a notification of the PBSS information of the PBSS 100-2 acquired in step S1503 to the communication management device 510 via the wireless LAN network 740.

In step S1505, similarly to the PCP 110-1, the PCP 110-3 acquires the PBSS information of the PBSS 100-3 formed by the PCP 110-3.

In step S1506, the PBSS information notifying unit 714 of the PCP 110-3 gives a notification of the PBSS information of the PBSS 100-3 acquired in step S1505 to the communication management device 510 via the wireless LAN network 740.

As described above, for example, each of the PCPs 110 according to the present embodiment periodically acquires the PBSS information of the PBSS formed by the PCP 110 and gives a notification of the PBSS information to the communication management device 510 via the wireless LAN network 740. For example, the PCP 110 may perform the acquisition and the notification of the PCSS information in response to a request from the communication management device 510.

In step S1507, the communication management device 510 collects the PBSS information reported from each of the PCPs 110 through the information collecting unit 732, and generates the connection information to be transmitted to each of the STAs 120 through the information generating unit 733.

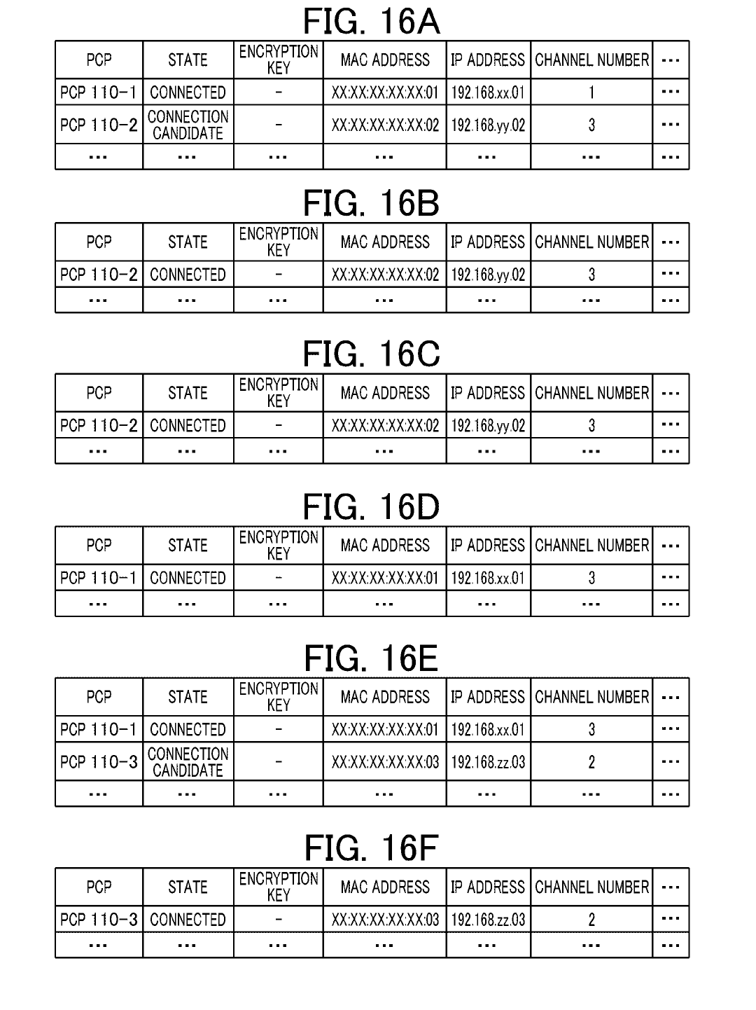

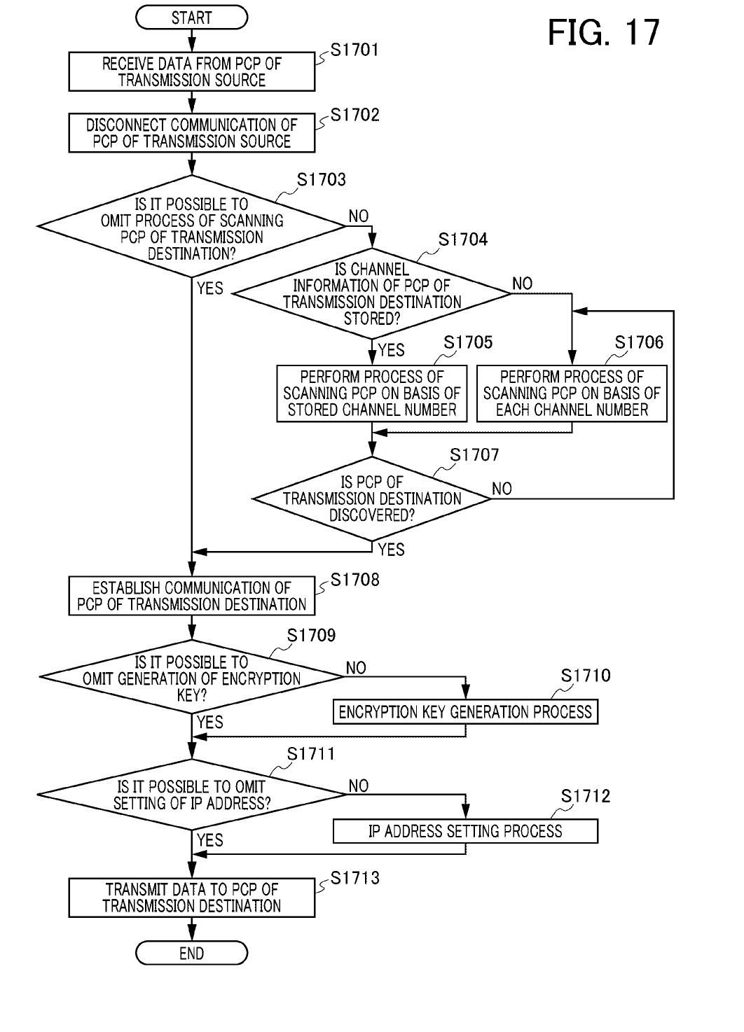

As an example, the information generating unit 733 of the communication management device 510 generates the connection information illustrated in FIGS. 16A to 16F for each STA 120. As another example, the information generating unit 733 may generate some items of information (for example, the “MAC address,” the “IP address,” the “channel number,” or the like) among the connection information illustrated in FIGS. 16A to 16F.

The information of the “PCP” and the “state” among the connection information illustrated in FIGS. 16A to 16F is assumed to be set by, for example, an administrator and stored by the communication path management unit 735 of the communication management device 510 in advance. Alternatively, the information collecting unit 732 of the communication management device 510 may decide the information of the “PCP” and the “state” on the basis of the PBSS information acquired from the PCPs 110-1 to 110-3.

In step S1508, the communication management device 510 gives a notification of the connection information of the STA 120-1 generated by the information generating unit 733 to the STA 120-1 via the wireless LAN network 740.

In step S1509, the connection information acquiring unit 725 of the STA 120-1 acquires the connection information reported from the communication management device 510 and stores the acquired connection information in the connection information storage unit 722.

In step S1510, the communication management device 510 gives a notification of the connection information of the STA 120-2 generated by the information generating unit 733 to the STA 120-2 via the wireless LAN network 740.

In step S1511, the connection information acquiring unit 725 of the STA 120-2 acquires the connection information reported from the communication management device 510 and stores the acquired connection information in the connection information storage unit 722.

Similarly, the communication management device 510 gives a notification of the connection information to the STAs 120-3 to 120-6, and the connection information acquiring unit 725 of the STAs 120-3 to 120-6 acquires the connection information reported from the communication management device 510 and stores the acquired connection information in the connection information storage unit 722.

Through the above process, for example, the connection information as illustrated in FIGS. 16A to 16F is stored in the connection information storage unit 722 of the STAs 120-1 to 120-6.

(Data Transfer Process of STA)

FIG. 17 is a flowchart of the data transfer process of the STA according to the fourth embodiment.

In step S1701, when the millimeter wave STA unit 721 receives data from the PCP 110 of the data transmission source, the STA 120 performs a process from step S1702.

In step S1702, the connection control unit 723 of the STA 120 performs the disconnection process for the millimeter wave wireless communication with the PCP 110 of the data transmission source.

In step S1703, the connection control unit 723 of the STA 120 determines whether or not the process of scanning the PCP 110 of the transfer destination can be omitted.

For example, when the MAC address and the channel number of the PCP 110 in the “connection candidate” state are stored in the connection information illustrated in FIG. 16A, the connection control unit 723 determines that the scanning process can be omitted and causes the process to proceed to step S1708.

On the other hand, when the MAC address and the channel number of the PCP 110 in the “connection candidate” state are not stored in the connection information illustrated in FIG. 16A, the connection control unit 723 determines that the scanning process is unable to be omitted and causes the process to proceeds to step S1704.

When the process proceeds to step S1704, the connection control unit 723 of the STA 120 determines whether or not the channel information (for example, the channel number) of the PCP 110 of the transfer destination is stored in the connection information stored in the connection information storage unit 722.

When the channel information of the PCP 110 of the transfer destination is stored in the connection information stored in the connection information storage unit 722, the connection control unit 723 of the STA 120 causes the process to proceed to step S1705.

On the other hand, when the channel information of the PCP 110 of the transfer destination is not stored in the connection information stored in the connection information storage unit 722, the connection control unit 723 of the STA 120 causes the process to proceed to step S1706.

When the process proceeds to step S1705, the STA 120 performs the process of scanning the PCP 110 on the basis of the channel number stored in the connection information storage unit 722 through the millimeter wave STA unit 721. On the other hand, when the process proceeds to step S1706, the STA 120 performs the PCP scanning process on the basis of each channel number (for example, channel numbers 1 to 3) through the millimeter wave STA unit 721.

As described above, when the channel information of the PCP 110 of the transfer destination is stored in the connection information stored in the connection information storage unit 722, since the number of channels for performing the process of scanning the PCP 110 can be reduced, it is possible to reduce the time required for the scanning process.

In step S1707, when the PCP 110 of the transfer destination is discovered, the STA 120 causes the process to proceed to step S1708. On the other hand, when the PCP 110 of the transfer destination is not discovered, the STA 120 causes the process to proceed to step S1706.

When the process proceeds to step S1708, the connection control unit 723 of the STA 120 performs the connection process for the millimeter wave wireless communication with the PCP 110 of transfer destination.

In step S1709, the connection control unit 723 of the STA 120 determines whether or not the generation of the encryption key can be omitted.

For example, when the encryption key of the PCP 110 of the transfer destination is stored in the connection information illustrated in FIG. 16A, the connection control unit 723 determines that the process of generating the encryption key can be omitted and causes the process to proceed to step S1711.

On the other hand, when the encryption key of the PCP 110 of the transfer destination is not stored in the connection information illustrated in FIG. 16A, the connection control unit 723 determines that the process of generating the encryption key is unable to be omitted and causes the process to proceed to step S1710.

When the process proceeds to step S1710, the millimeter wave STA unit 721 of the STA 120 performs the process of generating the encryption key for performing communication with the PCP 110 of the transfer destination through the millimeter wave wireless communication.

When the process proceeds to step S1711, the connection control unit 723 of the STA 120 determines whether or not the process of setting the IP address can be omitted.

For example, when the IP address of the PCP 110 of the transfer destination is stored in the connection information illustrated in FIG. 16A, the connection control unit 723 determines that the process of setting the IP address can be omitted and causes the process to proceed to step S1713.

On the other hand, when the IP address of the PCP 110 of the transfer destination is not stored in the connection information illustrated in FIG. 16A, the connection control unit 723 determines that the process of setting the IP address is unable to be omitted and causes the process to proceed to step S1712.

When the process proceeds to step S1712, the millimeter wave STA unit 721 of the STA 120 performs the process of setting the IP address with the PCP 110 of the transfer destination.

When the process proceeds to step S1713, the data transfer unit 724 of the STA 120 transmits (transfers) the data received from the PCP 110 of the transmission source to the PCP 110 of the transfer destination.

Through the above processing, the STA 120 can omit some of the processes for establishing communication with the PCP 110 of the transfer destination in accordance with the information stored in the connection information storage unit 722.

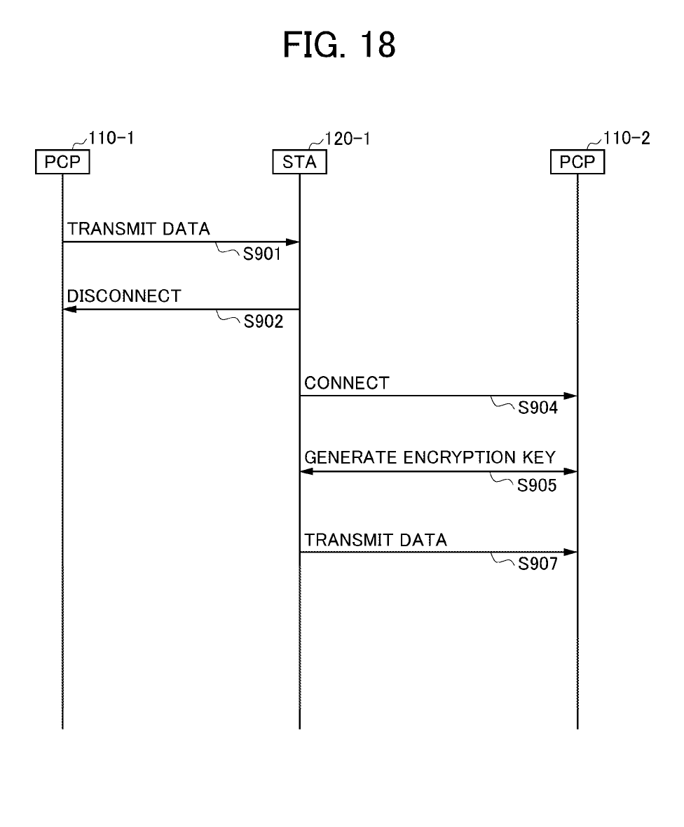

FIG. 18 is a sequence diagram illustrating an example of the connection process of the STA according to the fourth embodiment. The connection process of the STA 120 illustrated in FIG. 18 illustrates an example of the connection process performed when the STA 120-1 stores, for example, the connection information illustrated in FIG. 16A.

In the connection process of the STA 120-1 illustrated in FIG. 18, for example, the process of steps S903, S905, S906, and the like in the communication process (the connection process) of the STA 120 according to the first embodiment illustrated in FIG. 9 are omitted. Accordingly, the STA 120 can reduce the time for establishing the millimeter wave wireless communication with the PCP 110-2 and transfer the data received from the PCP 110-1 to the PCP 110-2 more rapidly.

The data transfer process of the STA 120 illustrated in FIG. 17 is an example. For example, in step S1508 of FIG. 15, the communication management device 510 may include information of a process to be omitted among the PCP scanning process, the process of generating the encryption key, and the process of setting the IP address or the like in the connection information to be transmitted to the STA 120-1 and transmit the resulting connection information.

In this case, the connection control unit 723 of the STA 120-1 can omit a designated process among the PCP scanning process, the encryption key generation process, and the process of setting the IP address and the like in accordance with the connection information reported from the communication management device 510 and perform the connection process.

(Data Transmission Process)

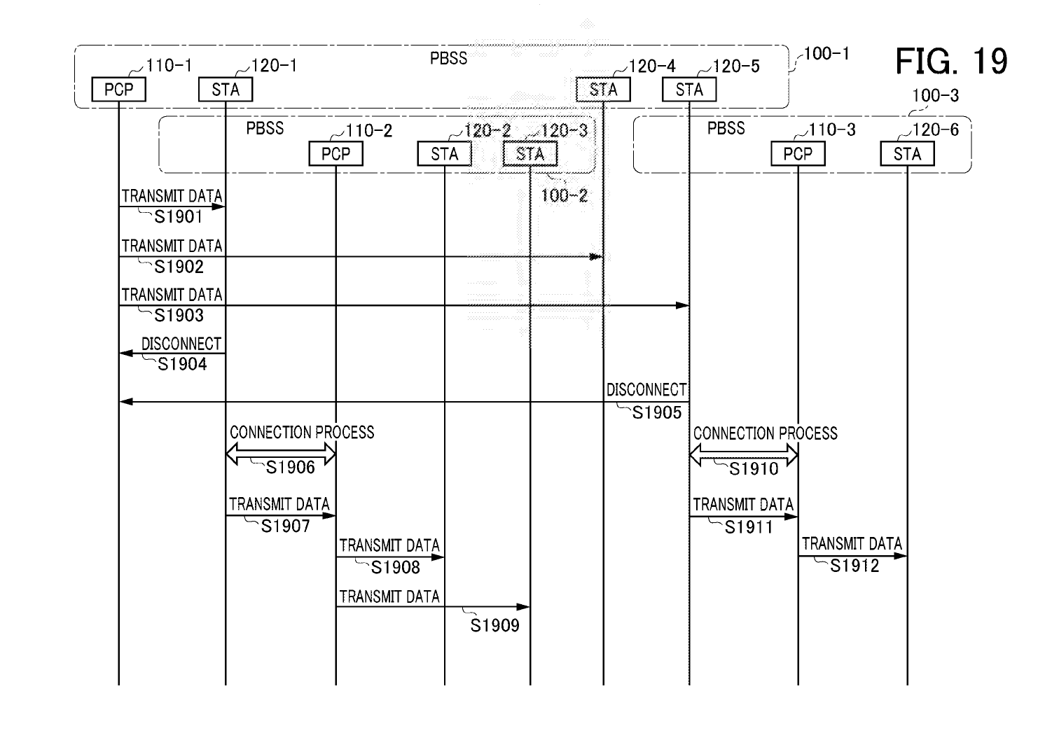

FIG. 19 is a sequence diagram illustrating an example of a data transmission process according to the fourth embodiment. The sequence diagram illustrated in FIG. 19 illustrates an example of communication process when predetermined data is simultaneously transmitted from the PCP 110-1 to the STAs 120-1 to 120-6 and the PCPs 110-2 to 110-3 in the communication system 500 illustrated in FIG. 5.

In steps S1901 to S1903, the PCP 110-1 transmits the predetermined data to the STAs 120-1, 120-4, and 120-5 connected to the PBSS 100-1 formed by the PCP 110-1 through the millimeter wave wireless communication.

In step S1904, the STA 120-1 performs the disconnection process for the millimeter wave communication with the PCP 110-1 on the basis of the connection information stored in the connection information storage unit 722.

For example, when the PCP 110 in the “connection candidate” state is stored as in the connection information illustrated in FIG. 16A, the STA 120 performs the disconnection process for the millimeter wave wireless communication with the PCP 110 in the “connected” state. On the other hand, when the PCP 110 in the “connection candidate” state is not stored as in the connection information illustrated in FIG. 16B, for example, the STA 120 does not perform the disconnection process for the millimeter wave wireless communication with the PCP 110 in the “connected” state.

In step S1905, the STA 120-5 performs the disconnection process for the millimeter wave communication with the PCP 110-1 on the basis of the connection information stored in the connection information storage unit 722.

In step S1906, the STA 120-1 performs the connection process illustrated in FIG. 18 with the PCP 110-2 in the “connection candidate” state, for example, on the basis of the connection information illustrated in FIG. 16A.

In step S1907, the data transfer unit 724 of the STA 120-1 transmits the predetermined data received from the PCP 110-1 in step S1901 to the PCP 110-2.

In steps S1908 and S1909, when the predetermined data is received from the STA 120-1, the PCP 110-2 transmits the received predetermined data to the STAs 120-2 and 120-3 connected to the PBSS 100-2 through the data transmitting unit 712.

In step S1910, the STA 120-5 performs the connection process as illustrated in FIG. 18 with the PCP 110-3 in the “connection candidate” state on the basis of the connection information illustrated in FIG. 16E.

In step S1911, the data transfer unit 724 of the STA 120-5 transmits the predetermined data received from the PCP 110-1 in step S1903 to the PCP 110-3.

In step S1912, when the predetermined data is received from the STA 120-5, the data transmitting unit 712 of the PCP 110-3 transmits the received predetermined data to the STA 120-6 connected to the PBSS 100-3 through the data transmitting unit 712.

Through the above processing, the communication system 500 according to the present embodiment can combine the communication devices (the PCP 110 and the STA 120) that perform communication with the one-to-one network configuration or the star-type network configuration centered on one communication device and perform hopping communication to a different network cell. The multihop communication is performed, and thus the high-speed data communication can be performed in a wider range.

In the communication system 500 according to the present embodiment, the communication management device 510 acquires the PBSS information from each of the PCPs 110 and gives a notification of the connection information to each of the STAs. Furthermore, each of the STAs can omit some processes in the connection process of establishing the millimeter wave wireless communication with PCP 110 on the basis of the notified connection information, whereby the time required for the data transfer can be reduced, and the data communication rate can be increased.

### Fifth Embodiment

The fourth embodiment has been described in connection with the example in which data is simultaneously transmitted from the PCP 110-1 to the STAs 120-1 to 120-6, the PCPs 110-2 and 110-3 or the like in the communication system 500 illustrated in FIG. 5.

A fifth embodiment will be described in connection with an example of a process when simultaneous data transmission or transmission in which a destination is designated is performed from an arbitrary STA 120 or the PCP 110 will be described.

(Information Provision Process)

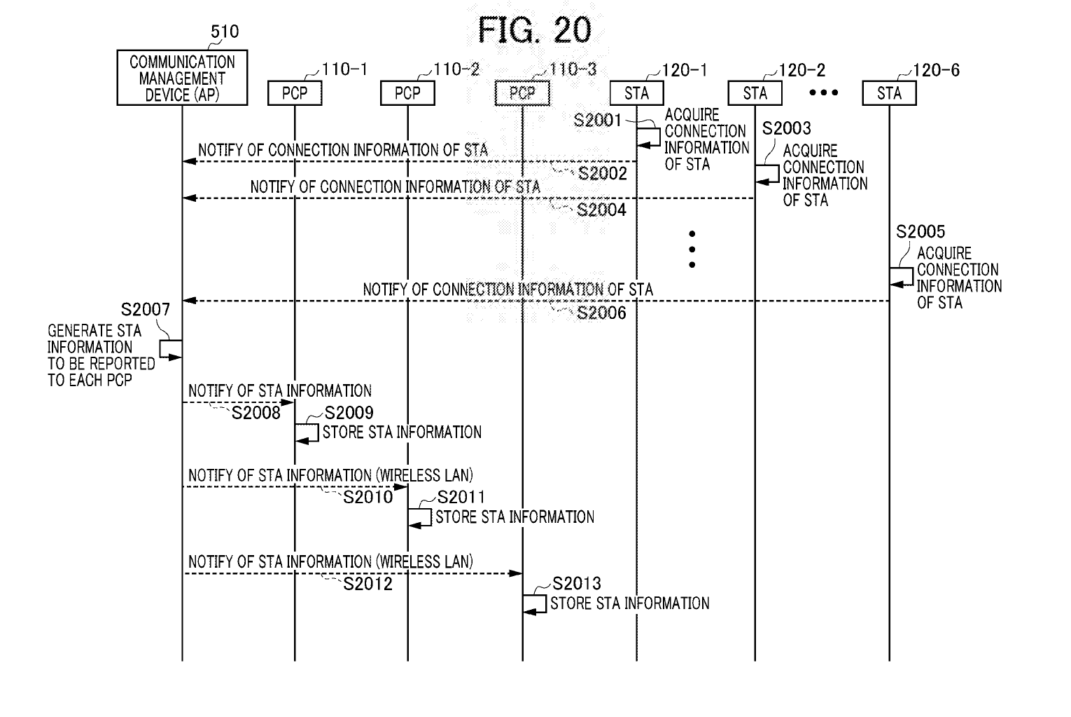

The communication management device 510 according to the present embodiment performs, for example, an information provision process as illustrated in FIG. 20 in addition to the information provision process according to the fourth embodiment illustrated in FIG. 15.

In step S2001, the STA information notifying unit 726 of the STA 120-1 acquires the connection information of the STA 120-1.

In step S2002, the STA information notifying unit 726 of the STA 120-1 gives a notification of the acquired communication information of the STA 120-1 to the communication management device 510 via the wireless LAN network 740.

Similarly, in steps S2003 to S2206, the STA information notifying unit 726 of the STAs 120-2 to 6 acquires the connection information of its own device and gives a notification of the acquired communication information to the communication management device 510 via the wireless LAN network 740.

The connection information reported from each of the STAs 120 to the communication management device 510 includes, for example, the connection information as illustrated in FIGS. 16A to 16F.

Preferably, the connection information to be reported from each of the STAs 120 to the communication management device 510 includes, for example, the information of the PCP 110 or the PBSS detected when each of the STAs 120 scans the PCP 110. Accordingly, the communication management device 510 can acquire the information of the PCP 110 that is able to communicate with each of the STAs 120 or the PBSS.

In step S2007, the communication management device 510 collects the STA information reported from each of the STAs 120 through the information collecting unit 732, and generates the STA information to be reported to each of the PCPs 110 through the information generating unit 733.

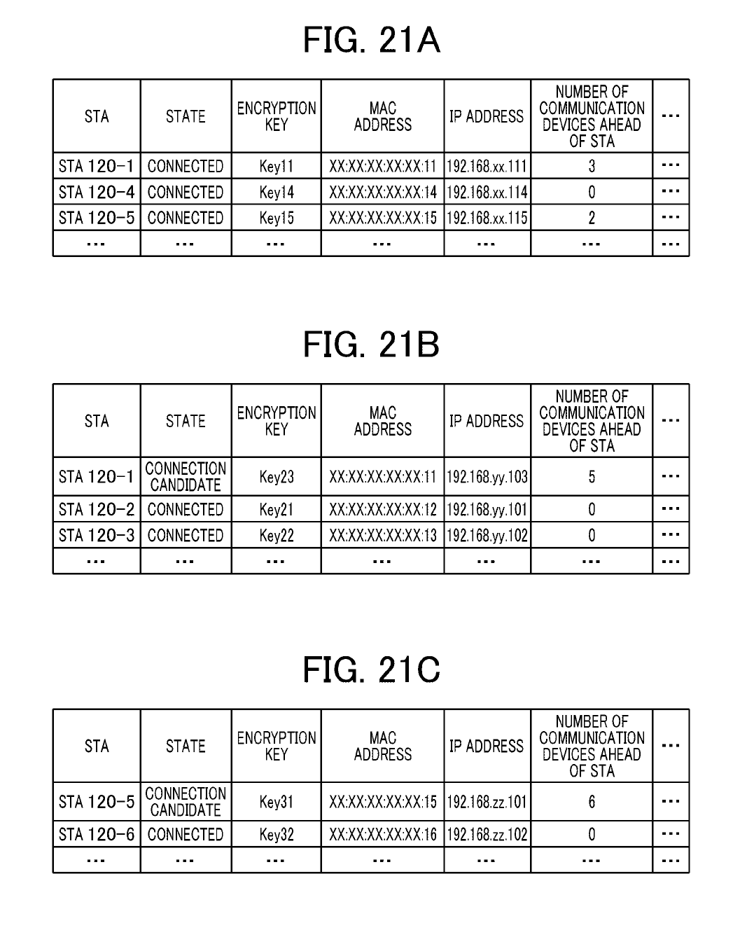

As an example, the information generating unit 733 of the communication management device 510 generates STA information illustrated in FIGS. 21A to 21C for each PCP 110. As another example, the information generating unit 733 may generate some items of information (for example, the “number of communication devices ahead of the STA”) among the STA information illustrated in FIGS. 21A to 21C.

The information of the “number of communication devices ahead of the STA” is information indicating the number of communication devices (the PCP 110 and the STA 120) that perform the millimeter wave wireless communication with the PCP 110 via each STA 120 in the “connected” state or the “connection candidate” state to the PCP 110. The communication path management unit 735 of the communication management device 510 calculates the information of the “number of communication devices ahead of the STA,” for example, using information indicating the communication path illustrated in FIG. 5.

For example, in the PCP 110-1 of FIG. 5, the number of communication devices communicating with the PCP 110-1 via the STA 120-1 is three, that is, the PCP 110-2, the STA 120-2, and the STA 120-3. In this case, as illustrated in FIG. 21A, the “number of communication devices ahead of the STA” corresponding to the STA 120-1 of the STA information reported to the PCP 110-1 is “3.”

Similarly, in the PCP 110-1 of FIG. 5, there is no communication device that communicates with the PCP 110-1 via the STA 120-4, and thus the “number of communication devices ahead of the STA” corresponding to the STA 120-1 is “0.” In the PCP 110-1 of FIG. 5, the number of communication devices communicating with the PCP 110-1 via the STA 120-5 is two, that is, the PCP 110-3 and the STA 120-6. In this case, the “number of communication devices ahead of the STA” corresponding to the STA 120-1 of the STA information reported to the PCP 110-1 is “2.”

In step S2008, the information providing unit 734 of the communication management device 510 transmits the STA information for the PCP 110-1 generated by the information generating unit 733 to the PCP 110-1.

In step S2009, the PCP 110-1 stores the STA information transmitted from the communication management device 510 in the STA information storage unit 713.

In step S2010, the information providing unit 734 of the communication management device 510 transmits the STA information for the PCP 110-2 generated by the information generating unit 733 to the PCP 110-2.

In step S2011, the PCP 110-2 stores the STA information transmitted from the communication management device 510 in the STA information storage unit 713.

In step S2012, the information providing unit 734 of the communication management device 510 transmits the STA information for the PCP 110-3 generated by the information generating unit 733 to the PCP 110-3.

In step S2013, the PCP 110-3 stores the STA information transmitted from the communication management device 510 in the STA information storage unit 713.

Through the above process, for example, the STA information illustrated in FIGS. 21A to 21C is stored in the STA information storage units 713 of the PCPs 110-1 to 110-3.

(Data Transfer Process of PCP)

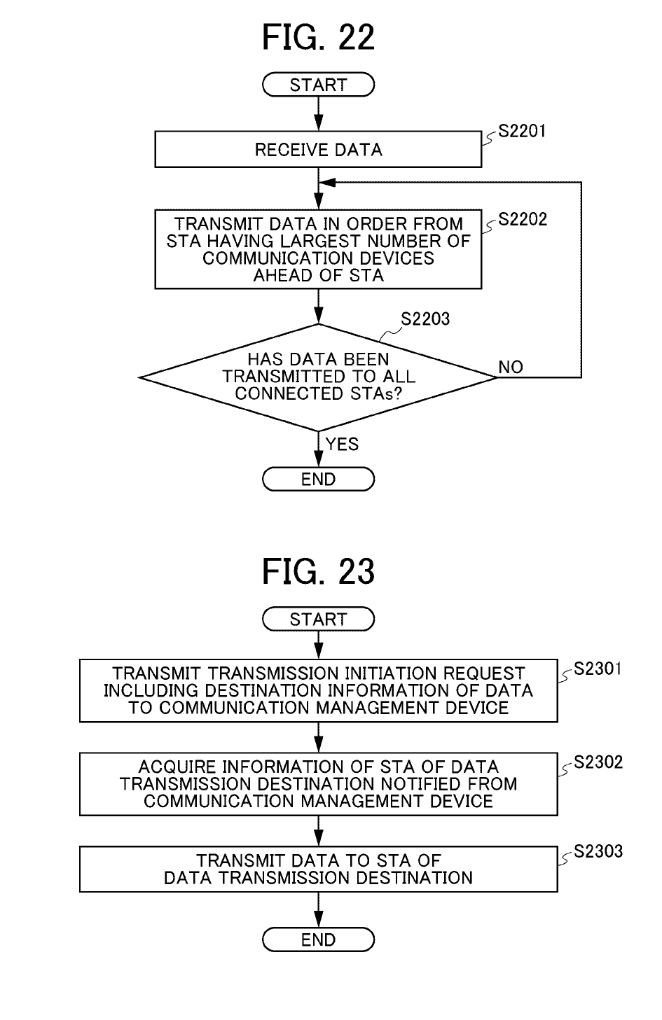

FIG. 22 is a flowchart of the data transfer process of the PCP according to the fifth embodiment. In the communication system 500, when data is received from one STA 120 connected to the PBSS 100 formed by the PCP 110, the PCP 110 transmits the received data to another STA 120 connected to the PBSS 100.

At this time, as illustrated in FIG. 22, it is desirable that the PCP 110 transmit the data in order from the STA having the largest number of communication devices ahead of the STAs.

In step S2201, when data is received from the STA 120, in step S2202, the PCP 110 transmits the data in order from the STA 120 having the largest number of communication devices ahead of the STAs on the basis of the STA information as illustrated in FIGS. 21A to 21C.

In step S2203, the PCP 110 repeats the process of step S2202 until the data is transmitted to all the STAs connected to the PBSS 100 formed by the PCP 110.

Since the data is transmitted in order from the STA 120 having the largest number of communication devices ahead of the STA 120 which is considered to require time until the data transmission is completed through the above process, it is possible to reduce the time until the transmission of all the data is completed.

(Data Transmission Process of PCP)

FIG. 23 is a flowchart of a data transmission process of the PCP according to the fifth embodiment. Each of the PCPs 110 performs a process illustrated in FIG. 23 when transmission of data is initiated.

In step S2301, the PCP 110 transmits a transmission initiation request of requesting initiation of data transmission to the communication management device 510 via the wireless LAN network 740. The transmission initiation request includes destination information indicating the destination of data (for example, simultaneous transmission, destination information of a transmission destination, or the like).

In step S2302, the PCP 110 acquires the information of the STA 120 of the data transmission destination from the communication management device 510 via the wireless LAN network 740.

In step S2303, the PCP 110 transmits data to a designated STA 120.

Thus, in the present embodiment, the communication management device 510 manages the communication path of the millimeter wave wireless communication, and a notification of the information of the STA 120 to which data is to be transmitted is given from the communication management device 510 in response to the transmission initiation request from the PCP 110.

(Data Transmission Process of STA)

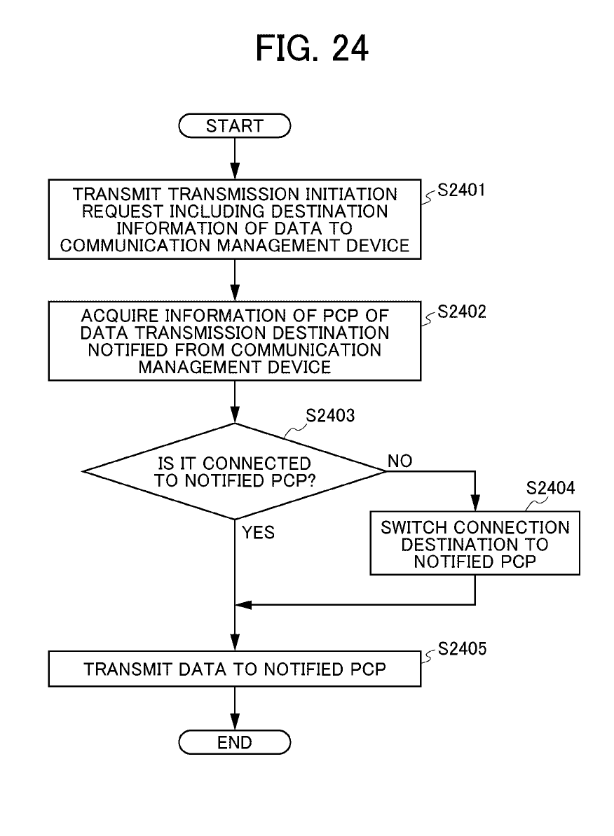

FIG. 24 is a flowchart illustrating an example of the data transmission process of the STA according to the fifth embodiment. Each of the STAs 120 performs a processing illustrated in FIG. 24 when transmission of data is initiated.

In step S2401, the STA 120 transmits the transmission initiation request of requesting initiation of data transmission to the communication management device 510 via the wireless LAN network 740. The transmission initiation request includes the destination information indicating the destination of data (for example, simultaneous transmission, destination information of a transmission destination, or the like).

In step S2402, the STA 120 acquires the information of the PCP 110 of the data transmission destination from the communication management device 510 via the wireless LAN network 740.

In step S2403, the STA 120 determines whether or not it is connected to the PCP 110 notified from the communication management device 510 (it is in the “connected” state or the “connection candidate” state).

When it is connected to the PCP 110 notified from the communication management device 510, the STA 120 causes the process to proceed to step S2405 On the other hand, when it is not connected to the PCP 110 notified from the communication management device 510, the STA 120 causes the process to proceed to step S2404.

When the process proceeds to step S2404, the STA 120 switches the connection destination to the PCP 110 notified from the communication management device 510.

When the process proceeds to step S2405, the STA 120 transmits data to the PCP 110 notified from the communication management device 510.

As described above, in the present embodiment, the communication management device 510 manages the communication path of the millimeter wave wireless communication, and a notification of the information of the PCP 110 to which data is to be transmitted is given from the communication management device 510 in response to the transmission initiation request from the STA 120. When the PCP 110 notified from the communication management device 510 is in the “connection candidate” state, the STA 120 transitions to the “connected” state and then transmits data to the PCP 110 notified from the communication management device 510.

(Communication Control Process of Communication Management Device)

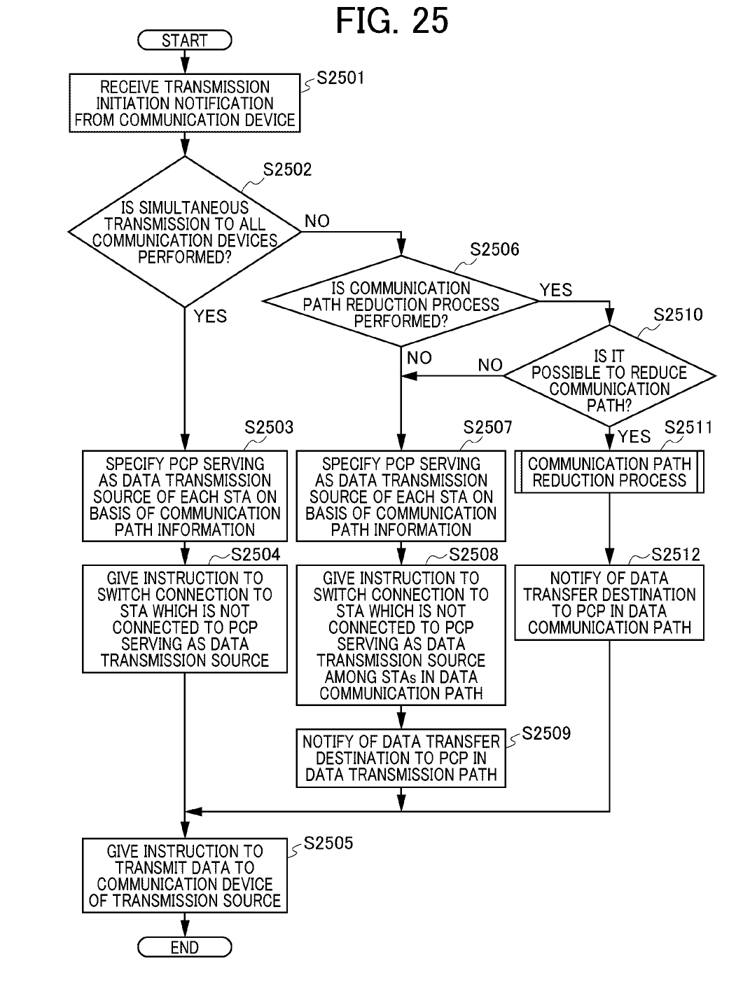

FIG. 25 is a flowchart of the communication control process of the communication management device according to the fifth embodiment. In the following description, the PCP 110 and the STA 120 may be referred to collectively as a “communication device.”

In step S2501, when the transmission initiation request is received from the communication device (the PCP 110 or the STA 120) via the wireless LAN network 740, the communication management device 510 performs a process from step S2502.

In step S2502, the communication management device 510 determines whether or not the destination included in the transmission initiation request is the simultaneous transmission to all the communication devices (the PCP 110 and the STA 120).

In the case of the simultaneous transmission to all the communication devices, the communication management device 510 causes the process to proceed to step S2503. On the other hand, when the determination is not the simultaneous transmission to all the communication devices, that is, when a destination is designated, the communication management device 510 causes the process to proceed to step S2506.

When the process proceeds to step S2503, the communication control unit 736 of the communication management device 510 specifies the PCP 110 serving as the data transmission source of each of the STAs 120 on the basis of the communication path information managed by the communication path management unit 735.

The communication management information managed by the communication path management unit 735 includes, for example, information indicating the connected state of each communication device illustrated in FIG. 5.

For example, in FIG. 5, when data is simultaneously transmitted to all the communication devices from the STA 120-2, the PCP 110 serving as the data transmission source of the STA 120-1 is the PCP 110-2. Likewise, the PCP 110 serving as the data transmission source of the STA 120-3 is the PCP 110-2. The PCP 110 serving as the data transmission source of the STA 120-4 is the PCP 110-1. The PCP 110 serving as the data transmission source of the STA 120-5 is the PCP 110-1. The PCP 110 serving as the data transmission source of the STA 120-6 is the PCP 110-3.

In step S2504, the communication control unit 736 of the communication management device 510 gives an instruction to switch a connection to the STA which is not connected to the PCP 110 serving as the data transmission source via the wireless LAN network 740.

For example, in the example of FIG. 5, since the STA 120-1 is not connected to the PCP 110-2 serving as the data transmission source, the communication control unit 736 of the communication management device 510 gives an instruction to switch a connection to the PCP 110-2 serving as the data transmission source to the STA 120-1.

In step S2505, the communication control unit 736 of the communication management device 510 gives an instruction to transmit the data to the communication device of the data transmission source via the wireless LAN network 740.

When the process proceeds to step S2506, the communication control unit 736 of the communication management device 510 determines whether or not a communication path reduction process is performed. For example, the communication control unit 736 of the communication management device 510 determines whether or not the communication system 500 is set to perform the communication path reduction process. The communication path reduction process is, for example, a process of directly transmitting data to the PBSS 100 including the communication device of the transmission destination without using the communication path illustrated in FIG. 5.

When the communication path reduction is performed, the communication management device 510 causes the process to proceed to step S2510. On the other hand, when the communication path reduction is not performed, the communication management device 510 causes the process to proceed to step S2507.

When the process proceeds to step S2507, the communication control unit 736 of the communication management device 510 specifies the PCP 110 serving as the data transmission source of each of the STAs 120 on the basis of the communication management information managed by the communication path management unit 735. This process may be similar to the process of step S2503 described above.

In step S2508, the communication control unit 736 of the communication management device 510 gives an instruction to switch a connection to the STA 120 which is not connected to the PCP serving as the data transmission source among the STAs 120 in the data communication path.

For example, in the communication system 500 illustrated in FIG. 5, when the STA 120-3 transmits data to the STA 120-5, the STA 120 in the data communication path becomes the STA 120-1. In this case, the communication control unit 736 of the communication management device 510 gives an instruction to switch a connection to the PCP 110-2 as the data transmission source to the STA 120-1 via the wireless LAN network 740.

In step S2509, the communication control unit 736 of the communication management device 510 gives a notification of the transfer destination of the data to the PCP 110 in the data communication path via the wireless LAN network 740.

When the process proceeds to step S2510, the communication control unit 736 of the communication management device 510 determines whether or not it is possible to reduce the communication path.

For example, in the information provision process illustrated in FIG. 20, the communication management device 510 acquires the information of the PBSS 100 detected by the PCP scanning of each of the STAs 120 from each of the STAs 120. Accordingly, the communication control unit 736 of the communication management device 510 can specify a connectable PBSS 100 from each of the STAs 120.

For example, when the communication device of the transmission source is the STA 120, and the STA 120 of the transmission source can detect the PBSS including the communication device of the transmission destination, the communication control unit 736 of the communication management device 510 determines that it is possible to reduce the communication path.

For example, when the communication device of the transmission source is the PCP 110, and the STA 120 of the PBSS 100 of the transmission destination can detect the PBSS 100 formed by the PCP 110 of the transmission source, the communication control unit 736 of the communication management device 510 determines that it is possible to reduce the communication path.

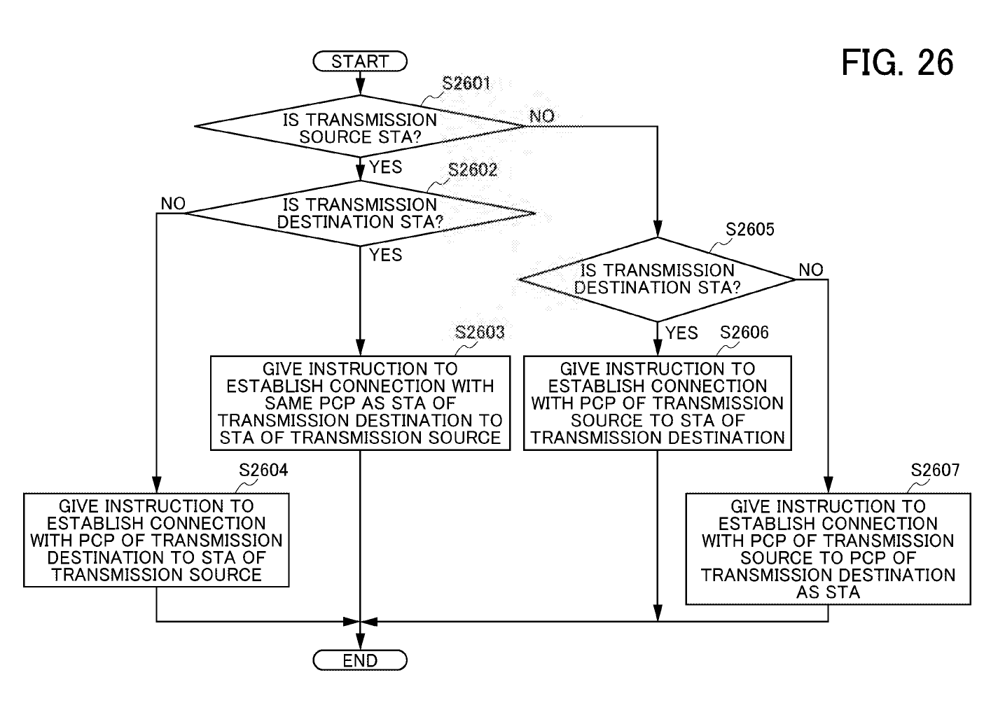

When it is determined that the communication path is unable to be reduced, the communication management device 510 causes the process to proceed to step S2507. On the other hand, when it is determined that it is possible to reduce the communication path, in step S2511, the communication control unit 736 of the communication management device 510 performs the communication path reduction process illustrated in FIG. 26.

In step S2512, the communication control unit 736 of the communication management device 510 gives a notification of the transfer destination of data to the PCP 110 in the data communication path via the wireless LAN network 740.

(Communication Path Reduction Process)

FIG. 26 is a flowchart of the communication path reduction process according to the fifth embodiment. This process corresponds to the communication path reduction process of step 2511 illustrated in FIG. 25.

In step S2601, the communication control unit 736 of the communication management device 510 determines whether or not the communication device of the transmission source is the STA 120.

When the communication device of the transmission source is the STA 120, the communication control unit 736 causes the process to proceed to step S2602. On the other hand, when the communication device of the transmission source is not the STA 120, that is, when the communication device of the transmission source is the PCP 110, the communication control unit 736 causes the process to proceed to step S2605.

When the process proceeds to step S2602, the communication control unit 736 of the communication management device 510 determines whether or not the communication device of the transmission destination is the STA 120.

When the communication device of the transmission destination is the STA 120, the communication control unit 736 causes the process to proceed to step S2603. On the other hand, when the communication device of the transmission destination is not the STA 120, that is, when the communication device of the transmission destination is the PCP 110, the communication control unit 736 causes the process to proceed to step S2604.

When the process proceeds to step S2603, the communication control unit 736 of the communication management device 510 gives an instruction to establish a connection with the same PCP 110 as the STA 120 of the transmission destination to the STA 120 of the transmission source.

When the process proceeds to step S2604, the communication control unit 736 of the communication management device 510 gives an instruction to establish a connection with the PCP 110 of the transmission destination to the STA 120 of the transmission source.

When the process proceeds to step S2605, the communication control unit 736 of the communication management device 510 determines whether or not the communication device of the transmission destination is the STA 120.

When the communication device of the transmission destination is the STA 120, the communication control unit 736 causes the process to proceed to step S2606. On the other hand, when the communication device of the transmission destination is not the STA 120, that is, when the communication device of the transmission destination is the PCP 110, the communication control unit 736 causes the process to proceed to step S2607.

When the process proceeds to step S2606, the communication control unit 736 of the communication management device 510 gives an instruction to establish a connection with the PCP 110 of the transmission source to the STA 120 of the transmission destination.

When the process proceeds to step S2607, the communication control unit 736 of the communication management device 510 gives an instruction to establish a connection with the PCP 110 of the transmission source as the STA 120 to the PCP 110 of the transmission destination. In this case, as the STA 120, the PCP 110 of the transmission destination connected to the PCP 110 of the transmission source is assumed to operate as the PCP 110 after the data transmission is completed or after a predetermined time elapses.

The communication path reduction process is optional and not essential.

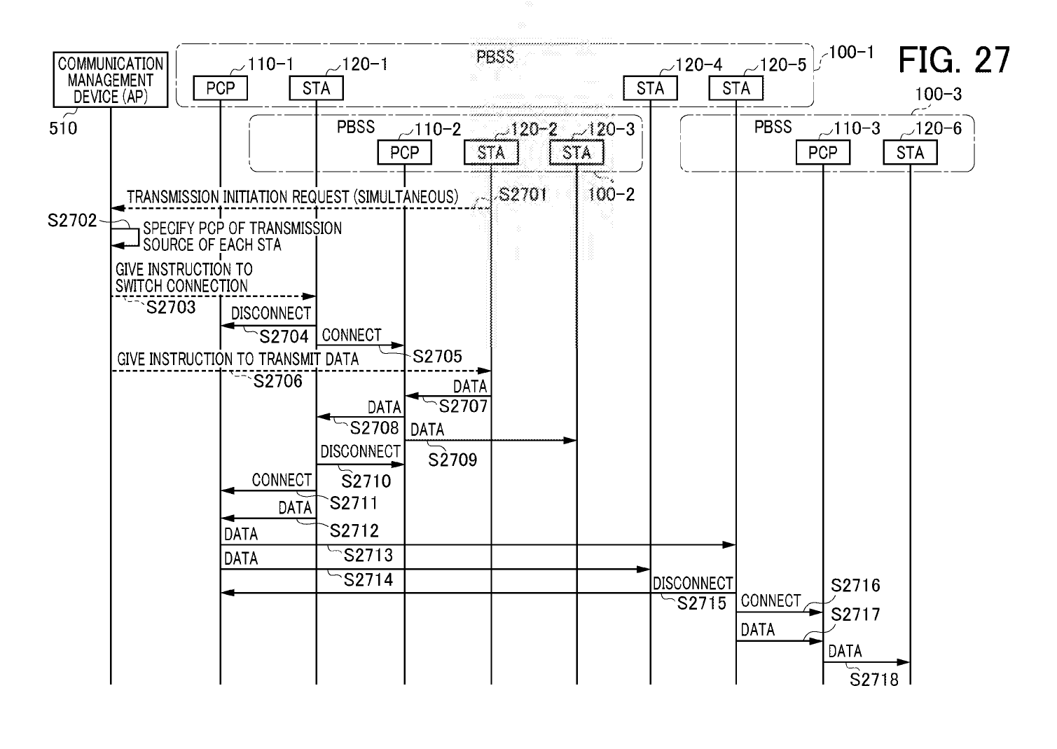

Next, an example of the data transmission process in the communication system 500 according to the present embodiment will be described with reference to FIGS. 27 to 29.

(Data Transmission Process 1)

FIG. 27 is a sequence diagram (1) illustrating an example of the data transmission process according to the fifth embodiment. This process is an example of the data transmission process when predetermined data is simultaneously transmitted from the STA 120-2 to other communication devices in the communication system 500 illustrated in FIG. 5.

In step S2701, the STA 120-2 of the transmission source that simultaneously transmits the predetermined data transmits a transmission initiation request for requesting simultaneous transmission of data to the communication management device 510 via the wireless LAN network 740.

In step S2702, the communication control unit 736 of the communication management device 510 specifies the PCP 110 serving as the data transmission source of each of the STAs 120 on the basis of the communication path information managed by the communication path management unit 735.

In step S2703, the communication control unit 736 of the communication management device 510 gives an instruction to switch a connection to the STA 120 which is not connected to the PCP 110 of the data transmission source specified in step S2702. In the communication system 500 illustrated in FIG. 5, as described above, since the STA 120-1 is not connected to the PCP 110-2 serving as the data transmission source, the communication control unit 736 gives an instruction to switch a connection to the STA 120-1 via the wireless LAN network 740.

In step S2704, the STA 120-1 that has received the instruction to switch the connection from the communication management device 510 disconnects the millimeter wave wireless communication with the PCP 110-1 in the “connected” state, and in step S2705, the STA 120-1 is connected to the PCP 110-2 through the millimeter wave wireless communication. Accordingly, the STA 120-2 of the transmission source is ready to transmit data.

In step S2706, the communication control unit 736 of the communication management device 510 gives an instruction to transmit the predetermined data to the STA 120-2 of the transmission source via the wireless LAN network 740.

In step S2707, the STA 120-2 of the transmission source transmits the predetermined data to the PCP 110-2 through the millimeter wave wireless communication.

In steps S2708 and S2709, the PCP 110-2 that has received the predetermined data from the STA 120-2 transmits the predetermined data to the STAs 120-1 and 120-3 which are other STAs 120 connected to the PCP 110-2 through the millimeter wave wireless communication.

In step S2710, the STA 120-1 that has received the predetermined data from the PCP 110-2 disconnects the millimeter wave wireless communication with the PCP 110-2, and in step S2711, the STA 120-1 establishes the millimeter wave wireless communication with the PCP 110-1.

In step S2712, the STA 120-1 transmits the predetermined data received from the PCP 110-2 to the PCP 110-1 through the millimeter wave wireless communication.

In steps S2713 and S2714, the PCP 110-1 that has received the predetermined data from the STA 120-1 transmits the predetermined data to the STAs 120-4 and 120-5 which are other STAs 120 connected to the PCP 110-1 through the millimeter wave wireless communication.

In step S2715, the STA 120-5 that has received the predetermined data from the PCP 110-1 disconnects the millimeter wave wireless communication with the PCP 110-1, and in step S2716, the STA 120-5 establishes the millimeter wave wireless communication with the PCP 110-3.

In step S2717, the STA 120-5 transmits the predetermined data received from the PCP 110-1 to the PCP 110-3 through the millimeter wave wireless communication.

In step S2718, the PCP 110-3 that has received the predetermined data from the STA 120-5 transmits the predetermined data to the STA 120-6 which is another STA 120 connected to the PCP 110-3 through the millimeter wave wireless communication.

According to the communication system 500 of the present embodiment, it is possible to simultaneously the predetermined data from an arbitrary communication device (the PCP 110 or the STA 120) to other communication terminals through the above process.

(Data Transmission Process 2)

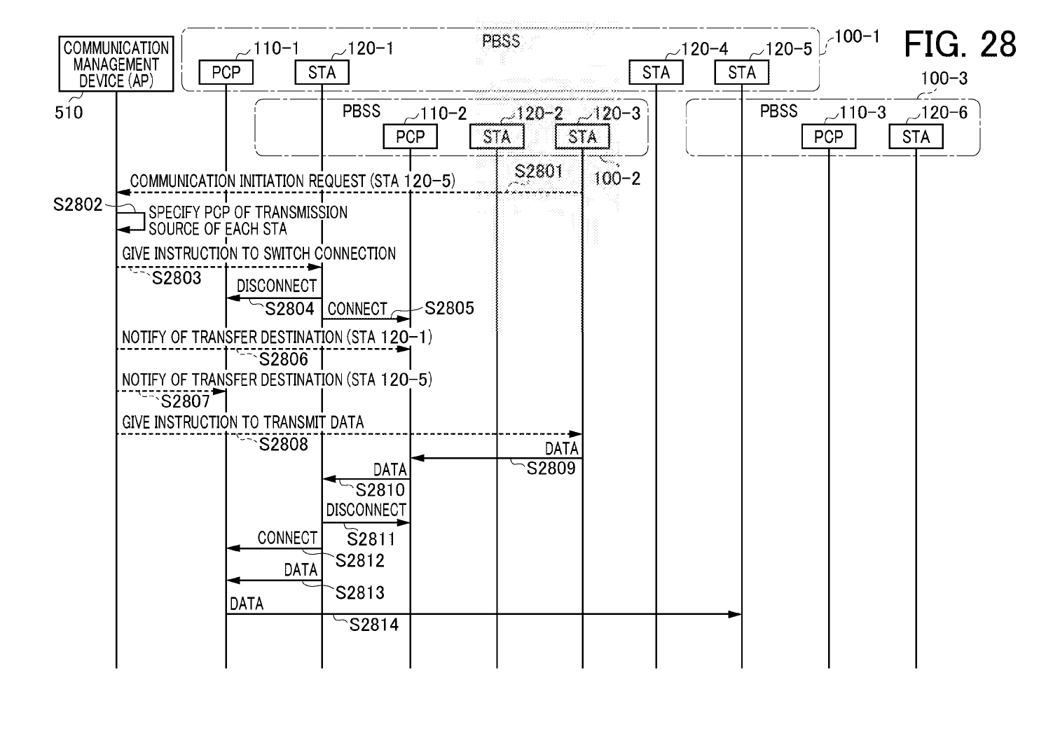

FIG. 28 is a sequence diagram (2) illustrating an example of the data transmission process according to the fifth embodiment. This process is an example of the data transmission process when predetermined data is transmitted from the STA 120-3 to the STA 120-5 which is an example of another communication device in the communication system 500 illustrated in FIG. 5.

In step S2801, the STA 120-3 of the transmission source that transmits the predetermined data to the STA 120-5 transmits the transmission initiation request of requesting transmission of data to the STA 120-5 to the communication management device 510 via the wireless LAN network 740.

In step S2802, the communication control unit 736 of the communication management device 510 specifies the PCP 110 serving as the data transmission source of each of the STAs 120 on the basis of the communication path information managed by the communication path management unit 735.

In step S2803, the communication control unit 736 of the communication management device 510 gives an instruct to switch a connection to the STA 120 which is not connected to the transmission source PCP 110 among the STAs 120 in the communication path from the STA 120-3 to the STA 120-5. In the communication system 500 illustrated in FIG. 5, since the STA 120-1 is not connected to the PCP 110-2 serving as the data transmission source, the communication control unit 736 gives an instruction to switch a connection to the STA 120-1 via the wireless LAN network 740.

In step S2804, the STA 120-1 that has received the instruction to switch the connection from the communication management device 510 disconnects the millimeter wave wireless communication with the PCP 110-1, and in step S2805, the STA 120-1 establishes a connection with the PCP 110-2 through the millimeter wave wireless communication.

In steps S2806 and S2807, the communication management device 510 gives a notification of the transfer destinations of data to the PCPs 110-2 and 110-1 in the communication path via the wireless LAN network 740.

In step S2808, the communication control unit 736 of the communication management device 510 gives an instruction to transmit the predetermined data to the PCP 110-2 to the STA 120-3 of the transmission source via the wireless LAN network 740.

In step S2809, the STA 120-3 of the transmission source transmits the predetermined data to the PCP 110-2 through the millimeter wave wireless communication.

In step S2810, the PCP 110-2 which has received the predetermined data from the STA 120-3 transmits the predetermined data to the STA 120-1 serving as the transfer destination notified from the communication management device 510 through the millimeter wave wireless communication.

In step S2811, the STA 120-1 that has received the predetermined data from the PCP 110-2 disconnects the millimeter wave wireless communication with the PCP 110-2, and in step S2812, the STA 120-1 establishes the millimeter wave wireless communication with the PCP 110-1.

In step S2813, the STA 120-1 transmits the predetermined data received from the PCP 110-2 to the PCP 110-1 through the millimeter wave wireless communication.

In step S2814, the PCP 110-1 which has received the predetermined data from the STA 120-1 transmits the predetermined data to the STA 120-5 serving as the transfer destination notified from the communication management device 510 through the millimeter wave wireless communication.

According to the communication system 500 of the present embodiment, it is possible to individually transmit the predetermined data from any communication device to other arbitrary communication terminals.

(Data Transmission Process 3)

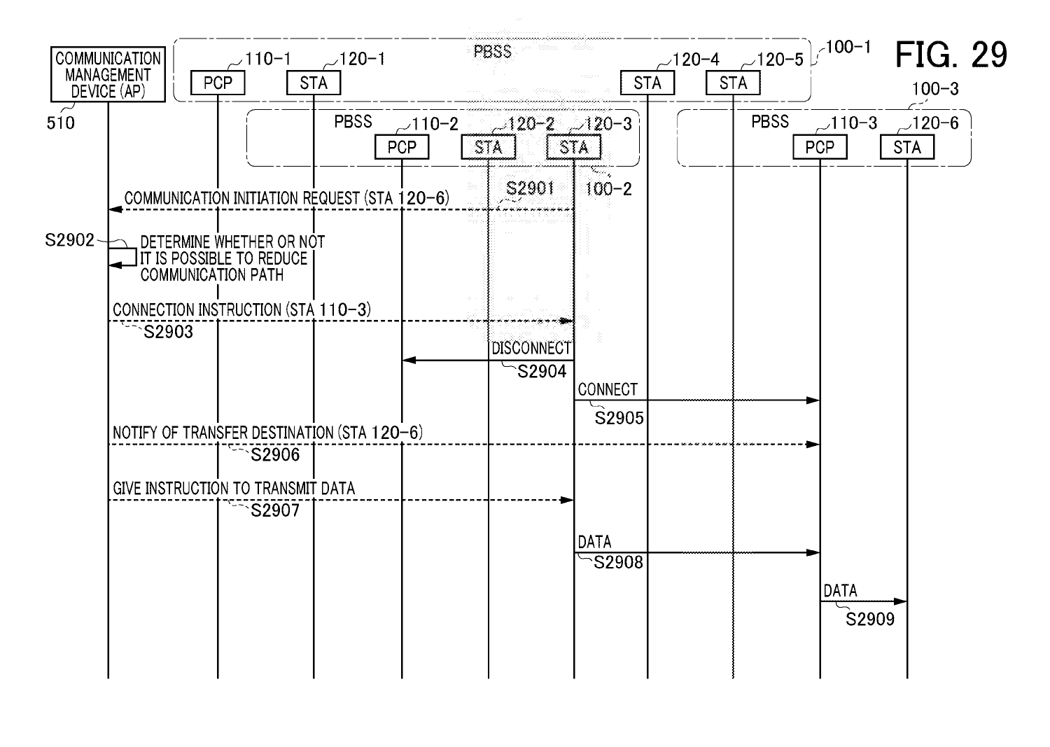

FIG. 29 is a sequence diagram (3) illustrating an example of the data transmission process according to the fifth embodiment. This processing is an example of the communication control process when the communication path reduction process is performed in the communication system 500 illustrated in FIG. 5. Here, the predetermined data is assumed to be transmitted from the STA 120-3 of the transmission source to the STA 120-6 of the transmission destination. Further, in the PCP search process of the STA 120-3, it is assumed that the PBSS 100-3 formed by the PCP 110-3 is detected, and a notification indicating the detection is given to the communication management device 510 as the STA information through the process of FIG. 20.

In step S2901, the STA 120-3 of the transmission source that transmits the predetermined data to the STA 120-6 transmits the transmission initiation request of requesting transmission of data to the STA 120-6 to the communication management device 510 via the wireless LAN network 740.

In step S2902, the communication control unit 736 of the communication management device 510 determines whether or not it is possible to reduce the communication path. Here, in the STA 120-3 of the transmission source, since the PBSS 100-3 formed by the PCP 110-3 to which the STA 120-6 of the transmission destination is connected is detected, the communication management device 510 determines that it is possible to reduce the communication path.

In step S2903, since the transmission source is the STA 120-3, and the transmission destination is the STA 120-6, the communication control unit 736 of the communication management device 510 gives an instruction to establish a connection with the PCP 110-3 to the STA 120-3 of transmission source in accordance with the communication path reduction process illustrated in FIG. 26.

In step S2904, the STA 120-3 of the transmission source that has received the instruction to establish the connection with the PCP 110-3 disconnects the millimeter wave wireless communication with the PCP 110-2, and in step S2905, the STA 120-3 of the transmission source establishes the millimeter wave wireless communication with the PCP 110-3.

In step S2905, the communication control unit 736 of the communication management device 510 gives a notification of the data transfer destination to the PCP 110-3 in the communication path via the wireless LAN network 740.

In step S2907, the communication control unit 736 of the communication management device 510 gives an instruction to transmit the predetermined data to the PCP 110-3 to the STA 120-3 of the transmission source via the wireless LAN network 740.

In step S2908, the STA 120-3 of the transmission source transmits the predetermined data to the PCP 110-3 through the millimeter wave wireless communication.

In step S2909, the PCP 110-3 which has received the predetermined data from the STA 120-3 transmits the predetermined data to the STA 120-6 serving as the transfer destination notified from the communication management device 510 through the millimeter wave wireless communication.

According to the communication system 500 of the present embodiment, it is possible to reduce the communication path when the predetermined data is individually transmitted from an arbitrary communication device to other arbitrary communication terminals through the above process.

### Sixth Embodiment

A sixth embodiment will be described in connection with an example in which an encryption key generated by the wireless LAN communication is used as an encryption key of the millimeter wave wireless communication.

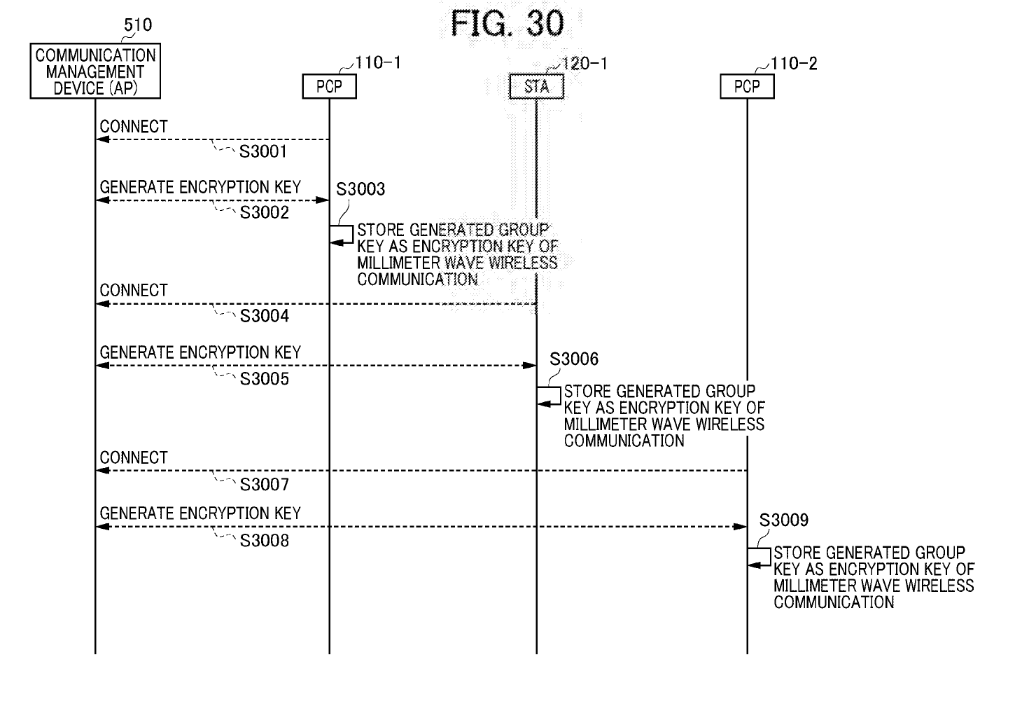

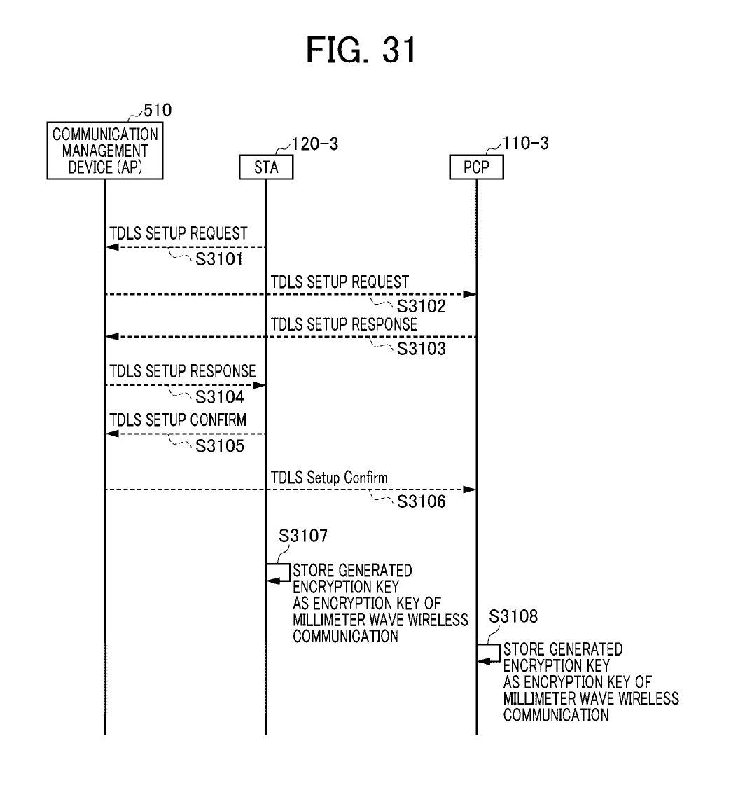

FIG. 30 is a sequence diagram illustrating an example of the encryption key sharing process according to the sixth embodiment. An initial stage of FIG. 30, the PCP 110-1, 110-2, and the STA 120-1 are assumed not to have established the connection with the communication management device 510 through the wireless LAN communication.

In step S3001, the PCP 110-1 performs the connection process with the communication management device 510 through the wireless LAN communication.

In step 3002, encryption keys are generated between the communication management device 510 and the PCP 110-1, for example, through a 4-way handshake.

In step S3003, the PCP 110-1 stores a group key (a group transient key (GTK)) used in multicast communication or broadcast communication among the encryption keys of the wireless LAN communication generated in step S3002 in the connection information storage unit 722 as an encryption key used in the millimeter wave wireless communication.

In step S3004, the STA 120-1 performs the connection process with the communication management device 510 through the wireless LAN communication.

In step 3005, the 4-way handshake is performed between the communication management device 510 and the STA 120-1 to generate encryption keys.

In step S3006, the STA 120-1 stores the group key used in multicast communication or broadcast communication among the encryption keys of the wireless LAN communication generated in step S3005 in the connection information storage unit 722 as the encryption key used in the millimeter wave wireless communication.

In step S3007, the PCP 110-2 performs the connection process with the communication management device 510 through the wireless LAN communication.

In step 3008, the 4-way handshake is performed between the communication management device 510 and the PCP 110-2 to generate encryption keys.

In step S3009, the PCP 110-2 stores the group key used in the multicast communication or the broadcast communication among the encryption keys of the wireless LAN communication generated in step S3008 in the connection information storage unit 722 as the encryption key used in the millimeter wave wireless communication.

Through the above process, the group key generated by the wireless LAN communication is stored in the communication devices (the PCP 110 and the STA 120) according to the present embodiment as the encryption key used in the millimeter wave wireless communication. Accordingly, the communication devices according to the present embodiment perform the millimeter wave wireless communication using the common group key generated through the wireless LAN communication.

Typically, the encryption key of the millimeter wave wireless communication is shared through the 4-way handshake, similarly to the wireless LAN. Therefore, the encryption key is typically generated through each of the wireless LAN and the millimeter wave wireless communication. On the other hand, in the present embodiment, the group key generated through wireless LAN is used in the millimeter wave wireless communication, and thus it is possible to simplify the procedure of generating the encryption key through the millimeter wave wireless communication and increase the data communication rate.

FIG. 31 is a sequence diagram illustrating another example of the encryption key sharing process according to the sixth embodiment.

In the wireless LAN communication, IEEE 802.11z (tunneled direct link setup (TDLS)) is known as a standard in which communication is performed between wireless LAN terminals without going through an access point.

In the wireless LAN communication of the normal infrastructure mode, communication is performed through the access point, and thus the communication throughput depends on capabilities of the access point, a congestion state, and the like. On the other hand, in TDLS, communication is performed between wireless LAN terminals without going through the access point, and thus it is possible to increase the communication rate.

In the present embodiment, an encryption key generated at the time of TDLS connection is used as the encryption key for the millimeter wave wireless communication. Accordingly, the security can be enhanced to be higher than in the example of FIG. 30 using the group key. At an initial stage of FIG. 31, the PCP 110-3 and the STA 120-3 are assumed to have completed the wireless LAN connection process with the communication management device 510.

In steps S3101 and S3102, for example, the STA 120-3 transmits a TDLS Setup Request of requesting a TDLS setup, for example, to the PCP 110-3 via the communication management device 510.

Preferably, this process is performed via the wireless LAN network 740, for example, when the STA 120-3 receives an instruction to establish a connection with the PCP 110-3 from the communication management device 510.

In steps S3103 and S3104, the PCP 110-3 transmits a TDLS Setup Response to the STA 120-3 as a response message to the TDLS Setup Request via the communication management device 510.

In steps S3105 and S3106, the STA 120-3 transmits a TDLS Setup Confirm to the PCP 110-3 as a confirmation message with respect to the TDLS Setup Request via the communication management device 510.

Through the above process, the TDLS encryption key is shared between the STA 120-3 and the PCP 110-3, and thus direct communication can be performed in accordance with TDLS.

Further, in the present embodiment, in step S3107, the STA 120-3 stores the generated TDLS encryption key in the connection information storage unit 722 as an encryption key for performing communication with the PCP 110-3 through the millimeter wave wireless communication.

In step S3108, the PCP 110-3 stores the generated TDLS encryption key in the STA information storage unit 713 as an encryption key for performing communication with the STA 120-3 through the millimeter wave wireless communication.

According to the present embodiment, since the encryption key generated by the wireless LAN communication is used as the encryption key used in the millimeter wave wireless communication, it is possible to omit the procedure of generating the encryption key for the millimeter wave wireless communication, and thus it is possible to increase the communication rate.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A communication system comprising:
a plurality of first communication devices configured to form different network cells through first wireless communication; and
a second communication device configured to communicate with the first communication devices through the first wireless communication,
the second communication device including:
a first memory to store connection information for establishing a connection with the plurality of first communication devices through the first wireless communication;
a communication circuit to connect, when data is received from one first communication device among the plurality of first communication devices, the second communication device with other first communication device different from the one first communication device through the first wireless communication using the connection information; and
circuitry to transfer the data received from the one first communication device by the second communication device to the other first communication device.

2. The communication system according to claim 1,
wherein the connection information includes first communication device information regarding the one first communication device to which the second communication device is connected through the first wireless communication and the other first communication device that the second communication device regards as a connection candidate in the first wireless communication.

3. The communication system according to claim 2,
wherein the first communication device information includes, for each of the one and other first communication devices, identification information of the network cell formed by the first communication device through the first wireless communication.

4. The communication system according to claim 2,
wherein the first communication device information includes, for each of the one and other first communication devices, channel information of the network cell formed by the first communication device through the first wireless communication.

5. The communication system according to claim 2,
wherein the first communication device information includes, for each of the one and other first communication devices, information of an IP address used by the second communication device through the first wireless communication with the first communication device.

6. The communication system according to claim 2,
wherein the first communication device information includes, for each of the one and other first communication devices, information of an encryption key used by the second communication device through the first wireless communication with the first communication device.

7. The communication system according to claim 2,
wherein the connection information includes, for each of the one and other first communication devices, information of a procedure to be omitted among procedures of establishing the first wireless communication with the first communication device.

8. The communication system according to claim 1,
wherein the second communication device is one of a plurality of second communication devices that is connected to the network cell formed by the first communication device, and
wherein at least one of the first communication devices includes a second memory to store second communication device information regarding the one second communication device connected to the network cell formed by the first communication device through the first wireless communication and other second communication device serving as a connection candidate connected to the network cell through the first wireless communication.

9. The communication system according to claim 8,
wherein the second communication device information includes, for each of the one and other second communication devices, information of an IP address which the first communication device uses in the first wireless communication with the second communication device.

10. The communication system according to claim 8,
wherein the second communication device information includes, for each of the one and other second communication devices, information of an encryption key which the first communication device uses in the first wireless communication with the second communication device.

11. The communication system according to claim 8,
wherein the second communication device information includes, for each of the one and other second communication devices, information indicating a number of other communication devices that communicate with the first communication device via the second communication device.

12. The communication system according to claim 11,
wherein the first communication device includes circuitry to transmit, when data is received from the one second communication device, the received data to the other second communication devices different from the one second communication device in a descending order of the number of other communication devices that communicate with the first communication device via the other second communication device.

13. The communication system according to claim 1, further comprising,
a third communication device configured to communicate through second wireless communication having a wider communication range than the first wireless communication,
wherein the third communication device includes circuitry to collect information of the network cell formed by the first communication device from the plurality of first communication devices through the second wireless communication, and provide at least some of the connection information to the second communication device through the second wireless communication based on the collected information.

14. The communication system according to claim 13,
wherein the circuitry of the third communication device manages information of a communication path by the first wireless communication of the communication system, and controls a connection destination of the second communication device in a communication path of data communication by the first wireless communication in response to receiving a transmission initiation request of requesting the data communication from the first communication device or the second communication device.

15. The communication system according to claim 14,
wherein the circuitry of the third communication device gives a notification of a data transfer destination of the data communication to the first communication device in the communication path of the data communication.

16. The communication system according to claim 13,
wherein the plurality of first communication devices and the second communication device perform encryption of the first wireless communication using an encryption key generated by the second wireless communication.

17. A communication device configured to communicate with a plurality of first communication devices and a second communication device through second wireless communication, the second communication device being configured to communicate with the plurality of first communication devices through first wireless communication, the second wireless communication having a wider communication range than the first wireless communication, the communication device comprising:
circuitry to collect information of different network cells which are formed by the first communication device, from the plurality of first communication devices through the second wireless communication; and
provide, based on the collected information, at least some of connection information to be used for the second communication device in establishing a connection with the first communication device through the first wireless communication, to the second communication device through the second wireless communication.

18. A non-transitory recording medium which, when executed by a processor, cause the processor to perform a communication method comprising:
storing, in a memory, connection information for establishing a connection with a plurality of first communication devices through first wireless communication, the plurality of first communication devices being configured to form different network cells through the first wireless communication;
connect, in response to receiving data from one first communication device among the plurality of first communication devices, a second communication device with other first communication device different from the one first communication device through the first wireless communication using the connection information; and
transferring the data received from the one first communication device by the second communication device to the other first communication device.
